(19) United States
(12) Patent Application Publication
(10) Pub. No.: US 2024/0314562 A1
(43) Pub. Date: Sep. 19, 2024

(54) INFORMATION PROCESSING DEVICE AND METHOD, AND PROGRAM

(71) Applicant: Sony Group Corporation, Tokyo (JP)

(72) Inventor: Noriyuki SUZUKI, Chiba (JP)

(73) Assignee: Sony Group Corporation, Tokyo (JP)

(21) Appl. No.: 18/575,669

(22) PCT Filed: Feb. 21, 2022
(86) PCT No.: PCT/JP2022/006923

§ 371 Date: Dec. 29, 2023

(30) Foreign Application Priority Data
Jul. 7, 2021 (JP) 2021-112492

(51) Int. Cl. H04W 12/069

(52) U.S. Cl. CPC H04W 12/069

(57) ABSTRACT

There is provided an information processing device and method, and a program that allow self-sovereign user authentication to be implemented in a simpler manner. The information processing device includes a session management unit that generates, for a transmission source device of an invitation code request for a DIDcomm connection, an invitation code including a session ID that identifies the DIDcomm connection, and performs control to record the session ID received over the DIDcomm connection from a connection destination device that has read the invitation code and a client ID that identifies the transmission source device included in the invitation code request with the session ID and the client ID associated with each other, and a communication unit that communicates with the connection destination device over the DIDcomm connection, in which in a case where the DIDcomm connection with the connection destination device has already been established, the session management unit reuses the DIDcomm connection with the connection destination device. The present technology may be applied to a verification server.

### TECHNICAL FIELD

The present technology relates to an information processing device and method, and a program, and more particularly to an information processing device and method, and a program that allow self-sovereign user authentication to be implemented in a simpler manner.

### BACKGROUND ART

Until now, in most cases of user authentication at a service site on a network, the authentication is performed using a user name and a password.

In such a case, the service site creates account information in advance by causing a user to register an ID and a password. Then, the authentication of the user requires the user to input the registered ID and password to obtain access to the service site.

The user, however, needs to manage different IDs and passwords for different services, and the service site also needs to prepare an account registration page and an authentication server on its own and manage confidential information of the user in a secure manner.

On the other hand, a federated identity system such as OpenID Connect (OIDC), which is a centralized ID platform, allows the ID of the user to be linked with an external authentication server and allows the user to reuse a single account. Furthermore, this eliminates the need for the service site to prepare the account registration page and the authentication server on its own and manage the confidential information of the user.

Moreover, as a technology concerning a centralized ID platform, a technology to perform authentication using an ID and a password and change a privilege in accordance with the password (see, for example, Patent Document 1), and a technology to separately provide a part for authenticating a user and a part for verifying the privilege of the user in order to improve efficiency in software module design (see, for example, Patent Document 2) have been proposed.

Such a centralized ID platform, however, has various risks arising from concentration of personal information in one place.

For example, there may be a risk of data leakage and a risk of personal information being used for unintended purposes without considering the intention of the user. Furthermore, the fact that the ID cannot be self-managed means that the user may suddenly lose his/her ID due to a policy change made by an entity responsible for managing the ID. In such a case, the user cannot use various linked services.

Therefore, a technology called self-sovereign identity (SSI) using a verifiable credential (VC) has attracted attention.

The VC is a W3C recommendation (see, for example, https://www.w3.org/TR/vc-data-model/) that defines a data model for representing credentials in an electronically verifiable manner.

The SSI is a technology to use the VC to make issued credentials electronically verifiable in a self-sovereign manner.

### CITATION LIST

### Patent Document

Patent Document 1: WO 2015/097927
Patent Document 2: Japanese Patent Application Laid-Open No. 2007-94674

### SUMMARY OF THE INVENTION

### Problems to be Solved by the Invention

It is, however, not easy to implement self-sovereign user authentication using the above-described SSI.

That is, for example, in order to implement the verifiable credential in an existing system for the implementation of the self-sovereign user authentication, it is necessary to integrate the function of the SSI into the service site or the like.

Furthermore, in order to establish a DIDcomm connection (see, for example, https://github.com/hyperledger/aries-rfcs/blob/master/concepts/0005-didcomm/README.md) in the SSI, it is first necessary to read an invitation code generated by a connection destination with a mobile application.

At this time, since a user who intends to log in to the service site or the like does not know whether or not the user already has an established connection, it is necessary to present the invitation code necessary for login every time, so that a new DIDcomm connection is established every time the user logs in. Accordingly, a procedure for the new connection is performed for each login, thereby requiring the user to perform many operation procedures, which takes time and effort.

Moreover, in a case where a process of issuing the VC starts in response to scanning of the invitation code displayed on a user registration screen with the mobile application, a VC issuing server needs to identify on which user registration screen the user has scanned the displayed invitation code.

Similarly, in a case where a login is performed in response to the scanning of the invitation code displayed on a login screen with the mobile application, a verification server needs to identify on which login screen the user has scanned the displayed invitation code.

It is therefore necessary to provide a mechanism for identifying on which screen the scanned invitation code has been displayed after the start of the DIDcomm connection.

The present technology has been made in view of such circumstances, and it is therefore an object of the present technology to allow self-sovereign user authentication to be implemented in a simpler manner.

### Solutions to Problems

An information processing device according to a first aspect of the present technology includes a session management unit that generates, for a transmission source device of an invitation code request for a DIDcomm connection, an invitation code including a session ID that identifies the DIDcomm connection, and performs control to record the session ID received over the DIDcomm connection from a connection destination device that has read the invitation code and a client ID that identifies the transmission source device included in the invitation code request with the session ID and the client ID associated with each other, and a communication unit that communicates with the connection destination device over the DIDcomm connection, in which in a case where the DIDcomm connection with the connection destination device has already been established, the session management unit reuses the DIDcomm connection with the connection destination device.

An information processing method or a program according to the first aspect of the present technology includes generating, for a transmission source device of an invitation code request for a DIDcomm connection, an invitation code including a session ID that identifies the DIDcomm connection, performing control to record the session ID received over the DIDcomm connection from a connection destination device that has read the invitation code and a client ID that identifies the transmission source device included in the invitation code request with the session ID and the client ID associated with each other; and communicating with the connection destination device over the DIDcomm connection, in which in a case where the DIDcomm connection with the connection destination device has already been established, the DIDcomm connection with the connection destination device is reused.

In the first aspect of the present technology, for the transmission source device of the invitation code request for the DIDcomm connection, the invitation code including the session ID that identifies the DIDcomm connection is generated, the session ID received over the DIDcomm connection from the connection destination device that has read the invitation code and the client ID that identifies the transmission source device included in the invitation code request are recorded with the session ID and the client ID associated with each other, and communication with the connection destination device is performed over the DIDcomm connection. Furthermore, in a case where the DIDcomm connection with the connection destination device has already been established, the DIDcomm connection with the connection destination device is reused.

An information processing device according to a second aspect of the present technology includes a readout unit that reads an invitation code for a DIDcomm connection that has been presented, a control unit that identifies, on the basis of the invitation code, whether or not the DIDcomm connection has already been established with a connection destination device indicated by the invitation code, and reuses the DIDcomm connection with the connection destination device in a case where the DIDcomm connection with the connection destination device has already been established, and a communication unit that transmits, to the connection destination device over the DIDcomm connection, a session ID that is included in the invitation code and identifies the DIDcomm connection with the connection destination device.

An information processing method or a program according to the second aspect of the present technology includes reading an invitation code for a DIDcomm connection that has been presented, identifying, on the basis of the invitation code, whether or not the DIDcomm connection has already been established with a connection destination device indicated by the invitation code and reusing the DIDcomm connection with the connection destination device in a case where the DIDcomm connection with the connection destination device has already been established, and transmitting, to the connection destination device over the DIDcomm connection, a session ID that is included in the invitation code and identifies the DIDcomm connection with the connection destination device.

In the second aspect of the present technology, the invitation code for the DIDcomm connection that has been presented is read, whether or not the DIDcomm connection has already been established with the connection destination device indicated by the invitation code is identified on the basis of the invitation code, the DIDcomm connection with the connection destination device is reused in a case where the DIDcomm connection with the connection destination device has already been established, and the session ID that is included in the invitation code and identifies the DIDcomm connection with the connection destination device is transmitted to the connection destination device over the DIDcomm connection.

### BRIEF DESCRIPTION OF DRAWINGS

FIG. 1 is a diagram for describing the present technology.

FIG. 2 is a diagram for describing a centralized ID federation technique and a technique according to the present technology.

FIG. 3 is a diagram illustrating a configuration example of a service providing system.

FIG. 4 is a flowchart for describing processing for VC issuance.

FIG. 5 is a flowchart for describing the processing for VC issuance.

FIG. 6 is a diagram illustrating an example of an invitation code request.

FIG. 7 is a diagram illustrating an example of setting information of a VC issuing server.

FIG. 8 is a diagram illustrating an example of an invitation code.

FIG. 9 is a diagram illustrating an example of an actual invitation code.

FIG. 10 is a diagram illustrating an example of session information.

FIG. 11 is a diagram illustrating an example of connection information.

FIG. 12 is a diagram illustrating an example of a start request.

FIG. 13 is a flowchart illustrating processing for authentication using an SSI certificate.

FIG. 14 is a flowchart illustrating the processing for authentication using an SSI certificate.

FIG. 15 is a diagram illustrating an example of setting information of a verification server.

FIG. 16 is a diagram illustrating an example of authentication information.

FIG. 17 is a diagram illustrating an example of an ID token.

FIG. 18 is a diagram for describing how to generate the ID token.

FIG. 19 is a diagram illustrating a configuration example of a computer.

### MODE FOR CARRYING OUT THE INVENTION

Hereinafter, an embodiment to which the present technology is applied will be described with reference to the drawings.

### First Embodiment

### <About Present Technology>

The present technology uses an ID token used in OpenID Connect or the like that is already in widespread use, so as to make self-sovereign user authentication available, with minimum extension, using a verifiable credential (VC) that is a credential.

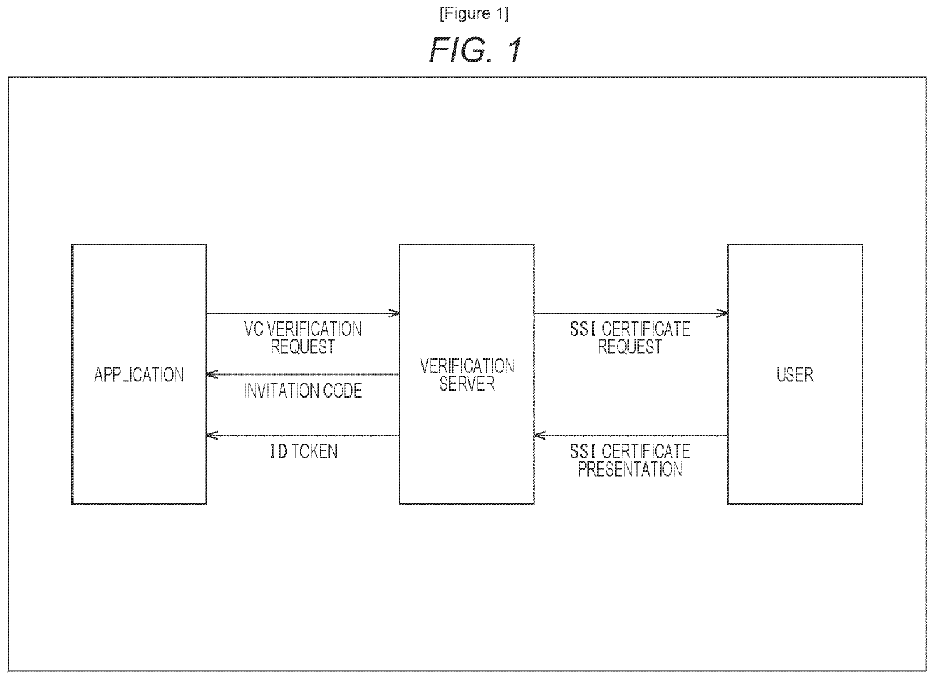

In the present technology, for example, as illustrated in FIG. 1, upon receipt of a VC verification request for a user from an application that is a relying party, a verification server that is a verification entity generates an invitation code including a SessionID (session ID) and returns the invitation code to the application.

Here, the SessionID is unique ID information (identification information) used for the verification server to identify a DIDcomm connection over an SSI network between the verification server and a device such as a user's smartphone.

Furthermore, the user can establish a connection with the verification server designated by the application by reading the invitation code presented from the application with an ID wallet application of the smartphone.

At this time, in a case where the DIDcomm connection with the verification server has already been established, that is, in a case where the DIDcomm connection with the verification server has been established in the past, the DIDcomm connection is reused. This eliminates the need for the user to perform a DIDcomm connection procedure every time the user logs in to the application. That is, this allows a reduction in number of user operations and a reduction in time and effort.

Furthermore, the ID wallet application of the user transmits the SessionID extracted from the invitation code to the verification server over the DIDcomm connection. This allows the verification server to associate the user with the application using the SessionID. In other words, the verification server can identify on which login screen the user has scanned (read) a displayed invitation code.

Moreover, when the DIDcomm connection has been established, the verification server transmits an SSI certificate request for user authentication to the user's smartphone.

Then, in response to the SSI certificate request, the user's smartphone generates an SSI certificate on the basis of a VC held in the user's smartphone, and presents the SSI certificate to the verification server.

When the verification server can verify that the user possesses the credential (VC) satisfying conditions by verifying the presented SSI certificate, the verification server generates an ID token on the basis of a conversion table. That is, the verification server converts (format-converts) the SSI certificate, which is a VC-based credential, into the ID token, which is a credential different in format from the SSI certificate, on the basis of the conversion table.

The ID token is a credential used in widely used protocols such as OpenID Connect.

The verification server transmits the ID token thus obtained to the application, and the application authenticates the user by verifying the ID token, and the user login is completed.

The user authentication using the VC described above eliminates the need for the application to have the SSI protocol directly implemented therein, so that it is possible to implement the self-sovereign user authentication with a relatively simple mechanism, that is, with minimum extension.

Furthermore, the verification server can skip the second and subsequent authentication processing by recording, for the user's smartphone, information regarding the DIDcomm connection for which authentication has already been completed, that is, information for the DIDcomm connection.

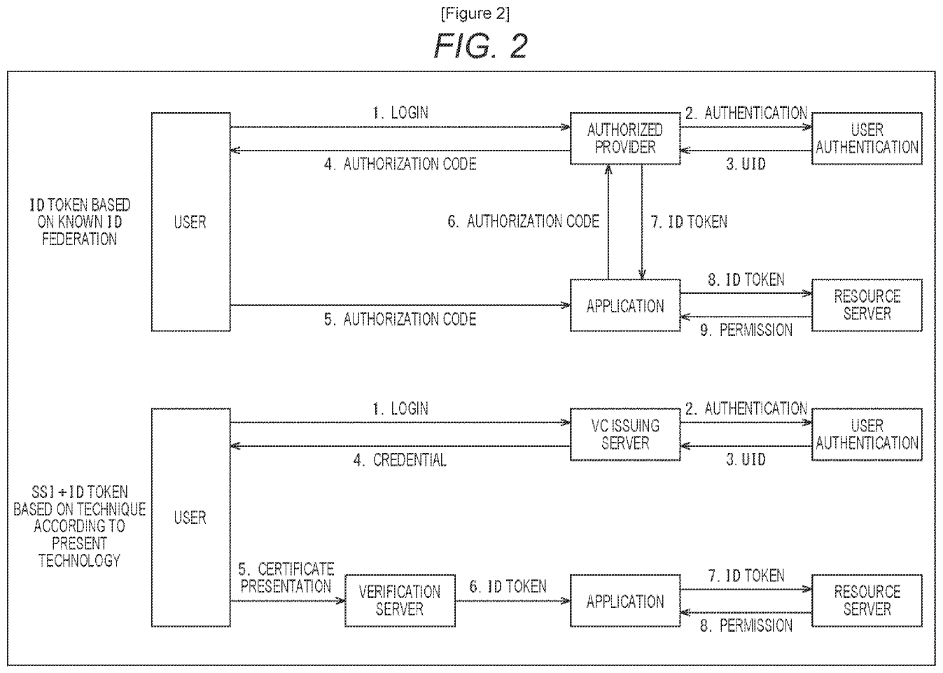

Here, a centralized ID federation technique and a technique using a combination of the SSI and the ID token according to the present technology will be compared and described with reference to FIG. 2.

The upper diagram of FIG. 2 illustrates a centralized ID federation technique using the ID token. In this ID federation technique, the user logs in to an authorized provider, and the authorized provider performs authentication of the user (user authentication) to obtain a user ID (UID) that identifies the user, and passes an authorization code to the user.

The user passes the authorization code thus obtained to any application seeking to receive a service, and the application presents the authorization code to the authorized provider to obtain the ID token that identifies the user from the authorized provider.

Then, the application transmits the ID token of the user to a resource server to obtain permission to access data (resource) on the user, the data being recorded in the resource server and being necessary for providing the service to the user.

The ID federation technique as described above causes the authorized provider, which is an issuer of the ID token, and the application, which is an authenticator of the user and uses the ID token, are connected without user intervention. Therefore, as described above, there is a risk such as unintended use of the user's personal information.

On the other hand, as illustrated in the lower diagram, in the technique using a combination of the SSI and the ID token according to the present technology, the user himself/herself manages the VC.

That is, when the user logs in to a VC issuing server, the VC issuing server performs user authentication to obtain the user ID (UID), and then issues a VC (credential) to the user. The user holds the issued VC in a wallet of his/her device in a secure manner.

Furthermore, in order to receive a service provided by any application, the user presents an SSI certificate generated on the basis of the held VC to the verification server.

Then, the verification server verifies the presented SSI certificate, generates an ID token from the SSI certificate, and passes the ID token to the application.

The application authenticates the user by verifying the ID token thus received and transmits the ID token of the user to the resource server to obtain permission to access the data (resource) on the user recorded in the resource server.

In the technique according to the present technology as described above, the VC issuing server, which is an issuer of the VC, and the application, which is an authenticator, are not directly connected, but are connected always with user intervention. As a result, self-sovereign user authentication is implemented, and it is possible to reduce a risk such as unintended use of personal information or the like.

In addition, the technique according to the present technology allows the application that provides a service to use a widely spread ID token as it is, which makes a change to the entire system to combine the SSI and the ID token as small as possible.

### <Configuration Example of Service Providing System>

Next, a service providing system to which the present technology is applied will be described.

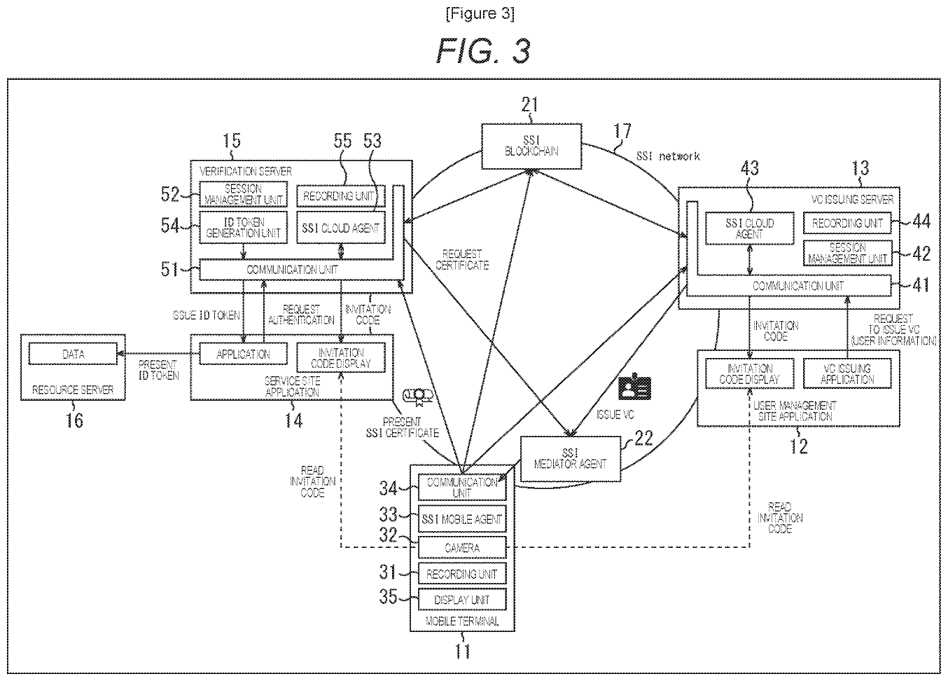

FIG. 3 is a diagram illustrating a configuration example of an embodiment of the service providing system to which the present technology is applied.

The service providing system illustrated in FIG. 3 includes a mobile terminal 11, a user management site application 12, a VC issuing server 13, a service site application 14, a verification server 15, a resource server 16, and an SSI network 17.

In this example, the mobile terminal 11, the VC issuing server 13, and the verification server 15 are connected to each other over the SSI network 17 that is a peer-to-peer P2P) network.

Furthermore, the SSI network 17 includes an SSI blockchain 21 and an SSI mediator agent 22 as components of the SSI network 17.

For example, in the SSI blockchain 21, information regarding a VC issued by the VC issuing server 13, a public key corresponding to a private key held by the VC issuing server 13, and the like are recorded.

The SSI mediator agent 22 mediates communication with the mobile terminal 11. That is, information transmitted from the mobile terminal 11 is directly transmitted to the VC issuing server 13 or the verification server 15 over the SSI network 17. On the other hand, information transmitted from the VC issuing server 13 or the verification server 15 toward the mobile terminal 11 is once held in the SSI mediator agent 22 and passed from the SSI mediator agent 22 to the mobile terminal 11.

Note that, in this example, the user management site application 12, the service site application 14, and the resource server 16 are not connected to the SSI network 17. It is therefore not necessary to implement the SSI protocol directly in the user management site application 12, the service site application 14, and the resource server 16.

The mobile terminal 11 includes an information processing device such as a smartphone or a tablet owned by a user, the information processing device including a recording unit 31, a camera 32 functioning as a readout unit, an SSI mobile agent 33, a communication unit 34, and a display unit 35.

For example, the SSI mobile agent 33 is implemented by a program recorded in the recording unit 31 and executed by a central processing unit (CPU) or the like (not illustrated) of the mobile terminal 11, and executes processing related to the issuance of a VC, the presentation of an SSI certificate, and the like over the SSI network 17. The SSI mobile agent 33 corresponds to the ID wallet application described with reference to FIG. 1, for example, and functions as a control unit.

In accordance with an instruction from the SSI mobile agent 33, the communication unit 34 performs communication over the SSI network 17, such as communication over the DIDcomm connection. Furthermore, the communication unit 34 communicates with the user management site application 12 or the service site application 14 over another network different from the SSI network 17.

The user management site application 12 includes, for example, an information processing device such as a server that runs a user management site for the issuance of a VC related to a service received by the user.

The VC issuing server 13 includes an information processing device such as a server, and issues a VC to the user in response to a request from the user management site application 12.

The VC issued by the VC issuing server 13 is an electronically verifiable digital credential, that is, digital personal information. More specifically, for example, the VC corresponds to a driver's license, a qualification certificate, a diploma, an insurance card, or the like, and is information (personal information) including one or a plurality of credential items such as a name of the user, an age of the user, and an address of the user.

The VC issuing server 13 includes a communication unit 41, a session management unit 42, an SSI cloud agent 43, and a recording unit 44.

For example, the session management unit 42 and the SSI cloud agent 43 are implemented by a program recorded in the recording unit 44 and executed by a CPU or the like (not illustrated) of the VC issuing server 13.

In accordance with an instruction from the SSI cloud agent 43, the communication unit 41 performs communication over the SSI network 17, such as communication over the DIDcomm connection. Furthermore, the communication unit 41 communicates with the user management site application 12 over another network different from the SSI network 17.

The session management unit 42 manages communication (session) with the mobile terminal 11 (SSI mobile agent 33) over the DIDcomm connection established on the SSI network 17.

The SSI cloud agent 43 functions as a VC issuance processing unit and executes processing related to the issuance of a VC to the user.

The service site application 14 provides a predetermined service to the user who is an owner of the mobile terminal 11.

At this time, the service site application 14 requests the verification server 15 to authenticate the user, and obtains an ID token used in OpenID Connect or the like issued in response to the request or accesses the resource server 16 using the ID token.

The verification server 15 includes, for example, an information processing device such as a server, generates (issues) an ID token on the basis of the SSI certificate presented by the mobile terminal 11 in response to a request from the service site application 14, and passes the ID token to the service site application 14.

The verification server 15 includes a communication unit 51, a session management unit 52, an SSI cloud agent 53, an ID token generation unit 54, and a recording unit 55.

For example, the session management unit 52, the SSI cloud agent 53, and the ID token generation unit 54 are implemented by a program recorded in the recording unit 55 and executed by a CPU (not illustrated) or the like of the verification server 15.

In accordance with an instruction from the SSI cloud agent 53, the communication unit 51 performs communication over the SSI network 17, such as communication over the DIDcomm connection. Furthermore, the communication unit 51 communicates with the service site application 14 over another network different from the SSI network 17.

The session management unit 52 manages communication (session) with the mobile terminal 11 (SSI mobile agent 33) over the DIDcomm connection established on the SSI network 17.

The SSI cloud agent 53 functions as a certificate verification unit, and executes processing related to the request to the user for an SSI certificate and the verification of the SSI certificate.

On the basis of the SSI certificate presented by the user, the ID token generation unit 54 generates an ID token corresponding to the SSI certificate.

The resource server 16 has various data (resources) on the user recorded therein, and passes the recorded data to the service site application 14 in response to the presentation of the ID token.

Roughly speaking, in the service providing system as described above, when the user receives a service, the following processing is executed.

That is, the user first receives the issuance of a necessary VC from the VC issuing server 13.

Specifically, the user can request the VC issuing server 13 to issue a VC by operating his/her mobile terminal 11 to input user information regarding the user himself/herself to the user management site of the user management site application 12.

In this case, after passing the user information input by the user to the VC issuing server 13 and requesting the VC issuing server 13 to issue a VC, the user management site application 12 receives an invitation code including a unique SessionID from the VC issuing server 13 and presents the invitation code.

Then, the mobile terminal 11 reads the presented invitation code with the camera 32, and establishes a DIDcomm connection with the VC issuing server 13 on the basis of the read invitation code.

When the DIDcomm connection with the VC issuing server 13 is established, the mobile terminal 11 transmits a SessionID included in the invitation code to the VC issuing server 13.

The VC issuing server 13 uses the SessionID received from the mobile terminal 11 to associate the mobile terminal 11 (SSI mobile agent 33), that is, the user, with the user information of the user, that is, the user management site application 12 that has requested the issuance of a VC.

The VC issuing server 13 generates a VC including the user information, and transmits the VC to the mobile terminal 11. That is, the VC is issued to the mobile terminal 11 (user).

When the VC is issued, the user can receive a service from the service site application 14 using the VC. Specifically, when the mobile terminal 11 accesses the service site application 14 to perform a login, the service site application 14 accesses the verification server 15, receives an invitation code including a unique SessionID, and presents the invitation code to the user.

Then, the mobile terminal 11 reads the presented invitation code with the camera 32, and establishes a DIDcomm connection with the verification server 15 on the basis of the read invitation code.

When the DIDcomm connection with the verification server 15 is established, the mobile terminal 11 transmits the SessionID included in the invitation code to the verification server 15.

The verification server 15 associates the mobile terminal 11 (SSI mobile agent 33), that is, the user, with the service site application 14 using the SessionID transmitted from the mobile terminal 11.

Furthermore, the verification server 15 requests the mobile terminal 11 (SSI mobile agent 33) to present an SSI certificate necessary for login to the service site application 14, that is, a service site run by the service site application 14.

In response to the request from the verification server 15, the mobile terminal 11 generates the requested SSI certificate using the VC held by itself and presents the SSI certificate to the verification server 15.

The verification server 15 verifies the SSI certificate presented by the mobile terminal 11, generates an ID token as a proof of the verification, and transmits the ID token to the service site application 14. That is, the ID token for the user is issued to the service site application 14 on the basis of the SSI certificate.

The service site application 14 performs user authentication by verifying the ID token issued by the verification server 15, and the login of the user is completed.

Thereafter, the service site application 14 transmits (presents) the ID token to the resource server 16 to obtain a right of access to data (resources) on the user, the data being recorded in the resource server 16 and being necessary for providing a service to the user.

Then, the service site application 14 reads the required data from the resource server 16 and provides the predetermined service to the user (mobile terminal 11) on the basis of the read data and the like.

### <Description of Processing for VC Issuance>

Next, processing executed in the service providing system will be described more specifically.

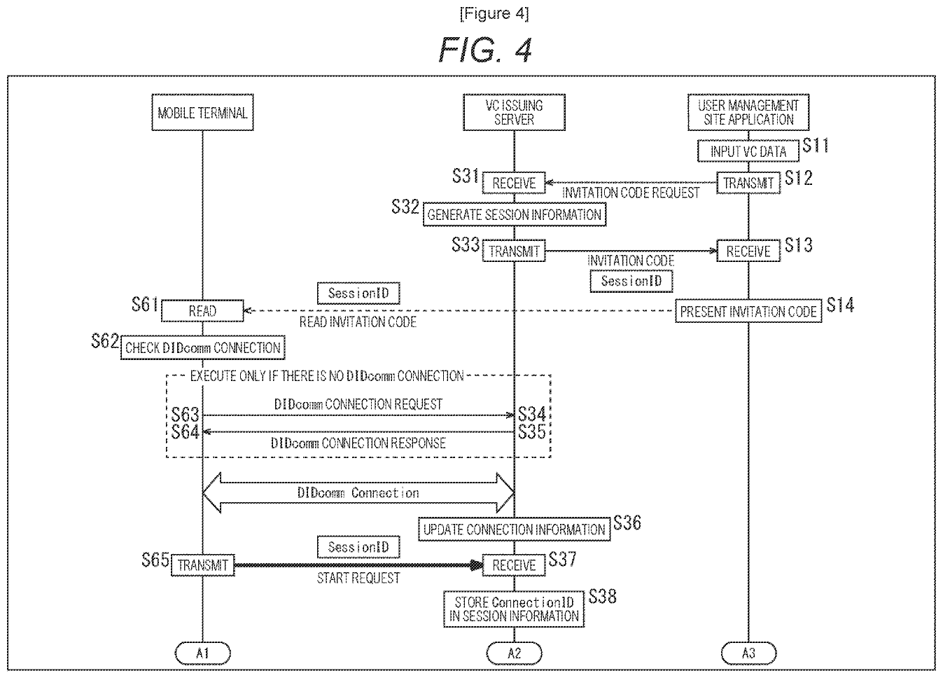

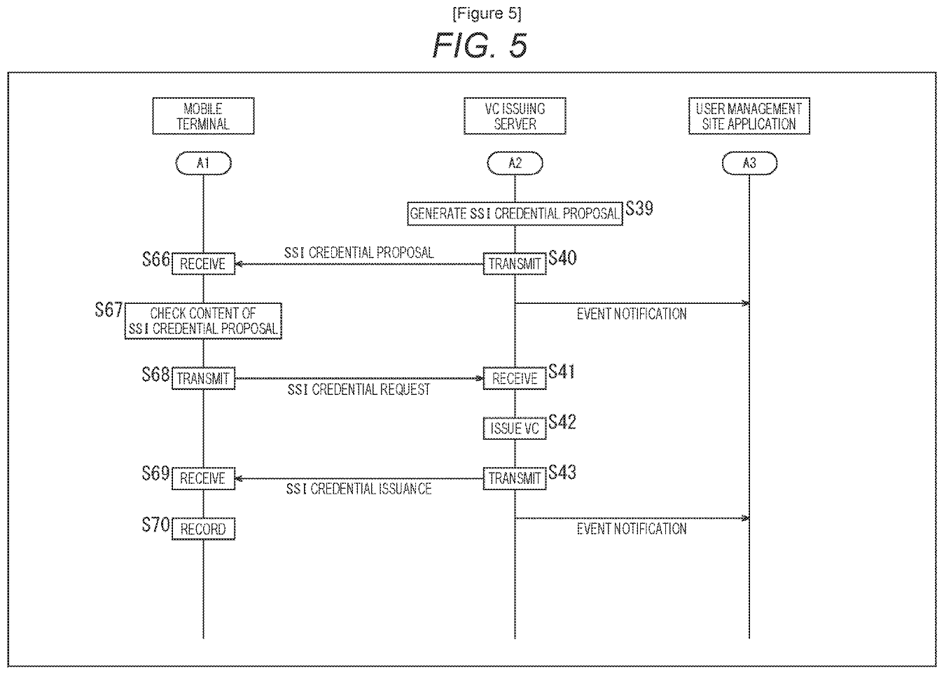

First, processing executed by the mobile terminal 11, the VC issuing server 13, and the user management site application 12 for VC issuance will be described with reference to flowcharts illustrated in FIGS. 4 and 5. In particular, FIG. 5 illustrates the continuation of the flowchart illustrated in FIG. 4.

First, in step S11, a VC issuing application of the user management site application 12 receives VC data input by the mobile terminal 11. Note that the VC data may be input by another terminal different from the mobile terminal 11, such as a Desktop application.

For example, the mobile terminal 11 accesses the user management site to receive the issuance of a VC including any user ID that identifies the user.

Then, for example, the user operates the mobile terminal 11 with the mobile terminal 11 and the user management site application 12 connected with each other to input, as the VC data, user information including information (personal information) regarding the user himself/herself, the user ID, and the like.

Then, since the VC data input by the user is passed (transmitted) from the communication unit 34 of the mobile terminal 11 to the user management site application 12, the VC issuing application of the user management site application 12 obtains (receives) and temporarily holds the VC data. Note that the example where the VC data such as the user information is input by the mobile terminal 11 has been described above, but the present technology is not limited to such an example, and the VC data may be input by another terminal different from the mobile terminal 11, such as a Desktop application.

In step S12, in order to issue a VC, the user management site application 12 transmits, to the VC issuing server 13, the input VC data (user information) and an invitation code request to request the issuance of an invitation code for establishing a DIDcomm connection. The invitation code request corresponds to a VC issuance request.

For example, the user management site application 12 has a client ID that identifies the user management site application 12 and a client secret that is an authentication code issued to the user management site application 12 (client) prerecorded therein.

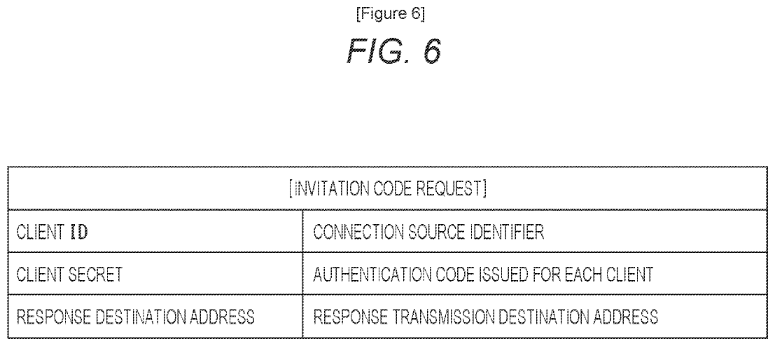

Then, as illustrated in FIG. 6, for example, the user management site application 12 generates an invitation code request including the prerecorded client ID and client secret and a response destination address.

In this example, the client ID is an identifier that identifies the user management site application 12 serving as a connection source client as viewed from the VC issuing server 13. Furthermore, the response destination address indicates an address of a transmission destination of a response to the invitation code request, and in this example, the address of the user management site application 12 is set as the response destination address.

Returning to the description of the flowchart in FIG. 4, in step S31, the communication unit 41 of the VC issuing server 13 receives the VC data (user information) and the invitation code request transmitted from the user management site application 12.

In step S32, the session management unit 42 of the VC issuing server 13 generates an invitation code and session information on the basis of the invitation code request received in step S31.

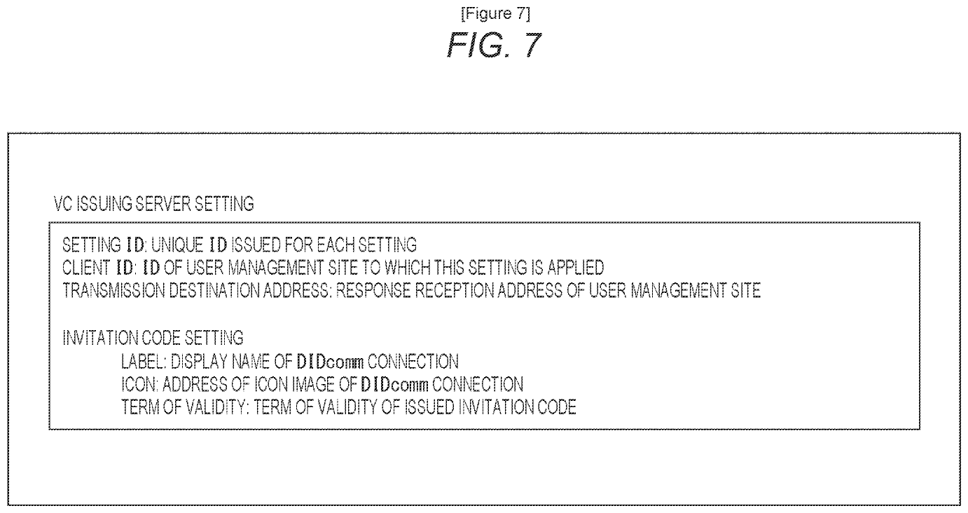

For example, the VC issuing server 13 assigns a unique client ID to each user management site application 12 serving as a client, and the recording unit 44 of the VC issuing server 13 has setting information, for example, as illustrated in FIG. 7, prerecorded therein for each client.

In the example illustrated in FIG. 7, the setting information includes a setting ID, a client ID, a transmission destination address, and an invitation code setting as setting items.

The setting ID is a unique ID issued for each setting related to the client (user management site application 12), that is, for each setting information.

The client ID is an ID (identifier) indicating the user management site application 12 to which the setting information is applied, and this client ID is included in the invitation code request.

Furthermore, the transmission destination address indicates an address of a transmission destination of a response to a request from the user management site application 12 (client), that is, a response reception address of the client. More specifically, when the invitation code request is generated, the transmission destination address is made to be a part of the response destination address included in the invitation code request. This prevents information from being leaked to the outside due to unauthorized addressing.

Moreover, the invitation code setting includes, as setting items, a label indicating a display name of the DIDcomm connection with the VC issuing server 13, an address of an icon image representing the DIDcomm connection, and information indicating a term of validity of the invitation code issued for the DIDcomm connection.

The VC issuing server 13 can make an individual setting as setting information for each client ID, that is, for each client.

Furthermore, when executing an application programming interface (API) of the VC issuing server 13, such as a process of making a response to the invitation code request, the VC issuing server 13 needs to transmit the client ID and the client secret issued for each client ID. Furthermore, unless both the client ID and the client secret are correct, the execution of the requested API is not permitted.

Therefore, the session management unit 42 authenticates the user management site application 12 on the basis of the client ID and the client secret included in the invitation code request from the user management site application 12 and the setting information recorded in the recording unit 44.

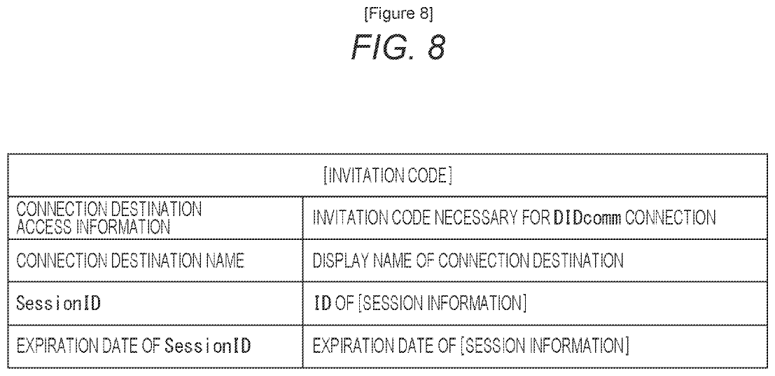

When the user management site application 12 is authenticated, the session management unit 42 generates an invitation code illustrated in FIG. 8, for example, on the basis of the setting information recorded in the recording unit 44.

In the example illustrated in FIG. 8, the invitation code includes connection destination access information, a connection destination name, a SessionID, and an expiration time of the SessionID.

The connection destination access information is a code (invitation code) necessary for the DIDcomm connection with the VC issuing server 13, and includes an address of the VC issuing server 13 that is an access destination.

The connection destination name is the name of a connection destination with which the DIDcomm connection is established, that is, information indicating the name of the VC issuing server 13 in this example, and the session management unit 42 stores the label included in the setting information as it is in the invitation code as the connection destination name.

The SessionID is ID information (identification information) that uniquely identifies the DIDcomm connection with the VC issuing server 13. The session management unit 42 stores the SessionID included in the session information to be described later and the expiration time of the SessionID as they are in the invitation code.

Furthermore, the session management unit 42 further stores, as appropriate, the address of the icon image included in the setting information recorded in the recording unit 44 in the invitation code.

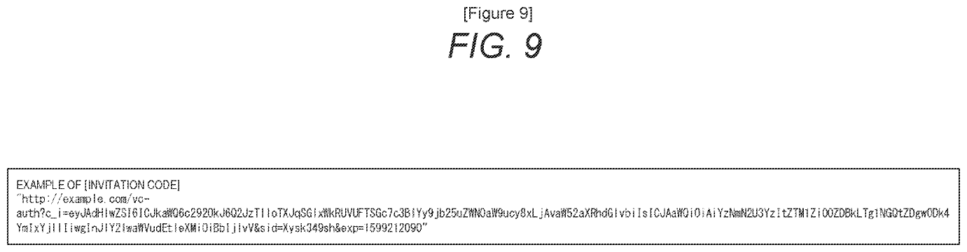

FIG. 9 illustrates an actual example of the invitation code as described above. In this example, a portion indicated by “c_i”, that is, a value of “c_i” indicates the connection destination access information (connection information) specified by the DIDcomm connection. Furthermore, a value of “sid” indicates the SessionID, and a value of “exp” indicates the expiration time of the SessionID.

Furthermore, the session management unit 42 further generates session information on the basis of the setting information recorded in the recording unit 44.

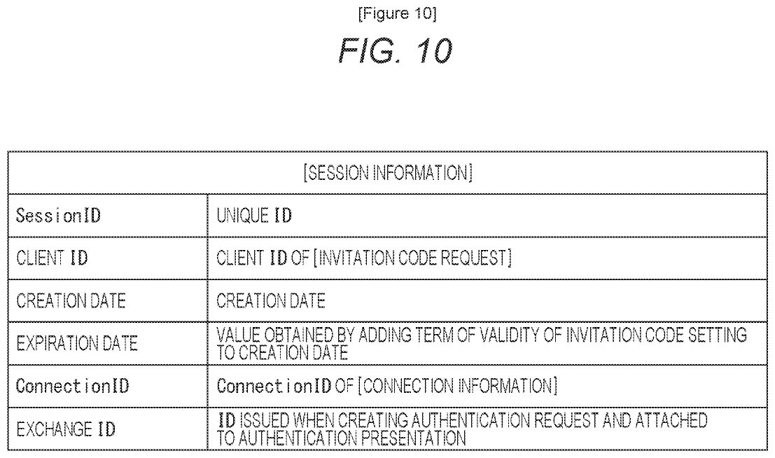

The session information is information regarding a DIDcomm connection over the SSI network 17, and is, for example, the information illustrated in FIG. 10.

In this example, the session information includes a SessionID, a client ID, a creation date, an expiration time, a ConnectionID (connection ID), and an exchange ID.

For example, the session management unit 42 stores the client ID included in the invitation code request received in step S31 as it is in the session information, and sets the current date as the creation date of the session information. Furthermore, the session management unit 42 stores a value (date) obtained by adding the term of validity in the invitation code setting in the setting information recorded in the recording unit 44 to the current date (creation date) in the session information as the expiration time of the session information.

Note that, although the session information includes the ConnectionID and the exchange ID in the example illustrated in FIG. 10, the session information including neither the ConnectionID nor the exchange ID is generated in step S32.

The ConnectionID is an ID (identification information) that is used in communication with the connection destination over the DIDcomm connection and uniquely identifies the DIDcomm connection with the connection destination. The ConnectionID includes the address of the connection destination over the DIDcomm connection in a manner similar to the connection destination access information.

Furthermore, the exchange ID is, as will be described later, an ID issued by the verification server 15 when creating a user authentication request and attached to the presentation of an SSI certificate, and is not included in the session information generated by the VC issuing server 13.

After the generation of the invitation code and the session information as described above, the session management unit 42 passes the invitation code to the communication unit 41 via the SSI cloud agent 43 and passes the session information to the recording unit 44 for recording.

Returning to the description of the flowchart in FIG. 4, in step S33, the communication unit 41 of the VC issuing server 13 transmits the invitation code generated in step S32 to the user management site application 12.

Then, in step S13, the user management site application 12 receives the invitation code including the SessionID transmitted by the VC issuing server 13.

In step S14, the user management site application 12 presents the invitation code received in step S13 to the mobile terminal 11, that is, the user.

In step S61, the SSI mobile agent 33 of the mobile terminal 11 controls the camera 32 or the like as appropriate to read (scan) the invitation code presented by the user management site application 12.

For example, in a case where the invitation code is displayed as a barcode such as a quick response (QR) code (registered trademark) on a display screen of the user management site application 12, the SSI mobile agent 33 reads the invitation code by causing the camera 32 to capture an image of the barcode.

Note that the invitation code may be printed as a barcode on a paper medium or the like, and the camera 32 may read the invitation code by capturing an image of the barcode.

Further, how to read the invitation code is not limited to such barcode reading, and any other method may be used.

For example, the invitation code may be read by the SSI mobile agent 33 that is activated via a deep link when a button displayed on the screen of the display unit 35 of the mobile terminal 11 is pressed. Furthermore, the invitation code may be read by the SSI mobile agent 33 that is activated via a deep link from a message such as an electronic mail or a short message service (SMS) received by the mobile terminal 11 from the user management site application 12.

Moreover, the invitation code may be read by means of wireless communication by holding the smartphone or the like as the mobile terminal 11 over a radio frequency identification (RFID) tag for reading the invitation code or a near field communication (NFC) port of the user management site application 12. The wireless communication by means of which the invitation code is read may be performed by Bluetooth (registered trademark), WiFi direct (registered trademark), or the like.

Alternatively, the invitation code may be transmitted by the user management site application 12 by means of optical communication such as infrared (IR) communication or visible light communication. In such a case, the smartphone or the like as the mobile terminal 11 reads the invitation code by receiving the transmitted invitation code with an IR light receiving unit or another light receiving unit as the communication unit 34, the camera 32, or the like.

Moreover, the mobile terminal 11 may read, by means of sound collection with a microphone, the invitation code transmitted as a sound signal by a speaker or the like, or may read the invitation code transmitted to the mobile terminal 11 over a wired connection such as a universal serial bus (USB) (registered trademark).

In step S62, the SSI mobile agent 33 of the mobile terminal 11 refers to, as appropriate, the information recorded in the recording unit 31 to check the content of the read invitation code, so as to confirm whether or not the DIDcomm connection with the VC issuing server 13 has already been established.

For example, the confirmation (identification) as to whether or not the DIDcomm connection has been established is performed on the basis of the invitation code read in step S61.

Specifically, for example, in a case where it is confirmed that the mobile terminal 11 has established the DIDcomm connection with the VC issuing server 13 in the past from the connection destination access information and the connection destination name included in the invitation code and the record (information) regarding a past DIDcomm connection recorded in the recording unit 31, the SSI mobile agent 33 determines that the DIDcomm connection has been established.

For example, a ConnectionID or the like is recorded in the recording unit 31 as a record regarding the past DIDcomm connection, and in a case where an address indicated by the ConnectionID is the same as an address indicated by the connection destination access information in the invitation code, it is determined that the DIDcomm connection has been established.

In a case where it is confirmed (determined) in step S62 that the DIDcomm connection has been established, the processes of steps S63 and S64 are skipped, and the processing proceeds to step S65 thereafter.

At this time, the SSI mobile agent 33 reuses the information regarding the past DIDcomm connection such as the ConnectionID recorded in the recording unit 31 to establish the DIDcomm connection with the VC issuing server 13. That is, the already established DIDcomm connection with the VC issuing server 13 is reused.

On the other hand, in a case where it is confirmed in step S62 that the DIDcomm connection has not been established, that is, in a case where the DIDcomm connection has never been established with the VC issuing server 13, the processes of steps S63 and S64 are executed to establish the DIDcomm connection. At this time, in the VC issuing server 13, the processes of steps S34 and S35 are executed in response to the processes in steps S63 and S64.

Specifically, the display unit 35 displays a connection confirmation screen for establishing the DIDcomm connection with the VC issuing server 13 on the basis of the invitation code. On this connection confirmation screen, for example, the connection destination name included in the invitation code, an icon image, a confirmation button used for confirming whether or not connection is possible, and the like are displayed. When the user confirms the displayed connection confirmation screen and presses the confirmation button by operating the mobile terminal 11, the process of step S63 is executed.

In step S63, the SSI mobile agent 33 reads, as appropriate, information regarding the mobile terminal 11, that is, the user, recorded in the recording unit 31, generates a DIDcomm connection request from the read information, and causes the communication unit 34 to transmit the DIDcomm connection request.

For example, the DIDcomm connection request is a message including a label indicating an identification name of the mobile terminal 11 and a DID and access information of the mobile terminal 11.

The DID included in the message is an ID (identification information) that is managed by the SSI blockchain 21 and uniquely identifies the mobile terminal 11 over the DIDcomm connection established with the VC issuing server 13 over the SSI network 17.

Furthermore, the access information of the mobile terminal 11 is, for example, information necessary for communication with (access to) the mobile terminal 11 over the DIDcomm connection, and is, for example, a DID document including a public key and the like of the mobile terminal 11.

Moreover, more specifically, the invitation code includes the public key of the VC issuing server 13. The SSI mobile agent 33 encrypts the message including the label, the DID, and the access information of the mobile terminal 11 with the public key of the VC issuing server 13 to generate the DIDcomm connection request, and passes the DIDcomm connection request to the communication unit 34.

The communication unit 34 transmits the DIDcomm connection request passed from the SSI mobile agent 33 to the VC issuing server 13 over the SSI network 17.

Then, in step S34, the communication unit 41 of the VC issuing server 13 receives the DIDcomm connection request transmitted from the mobile terminal 11.

The session management unit 42 decrypts the received message of the DIDcomm connection request with the private key of the VC issuing server 13 recorded in the recording unit 44 to extract the label, the DID, and the access information of the mobile terminal 11 from the DIDcomm connection request. The label, the DID, and the access information may be passed to and recorded in the recording unit 44 as appropriate.

Furthermore, the session management unit 42 reads, as appropriate, necessary information from the recording unit 44 in response to the DIDcomm connection request, and generates a DIDcomm connection response that is a message including a label indicating an identification name of the VC issuing server 13 and a DID and access information of the VC issuing server 13.

At this time, the session management unit 42 encrypts the message of the DIDcomm connection response on the basis of the access information (public key) of the mobile terminal 11 extracted from the DIDcomm connection request. Furthermore, the session management unit 42 passes the generated DIDcomm connection response to the communication unit 41.

Note that the label, the DID, and the access information included in the message of the DIDcomm connection response are similar to the label, the DID, and the access information included in the DIDcomm connection request. Therefore, for example, the DID of the VC issuing server 13 is an ID that is managed by the SSI blockchain 21 and uniquely identifies the VC issuing server 13 over the DIDcomm connection established with the mobile terminal 11 over the SSI network 17.

In step S35, the communication unit 41 transmits the DIDcomm connection response passed from the session management unit 42 to the mobile terminal 11 over the SSI network 17.

Then, in step S64, the communication unit 34 of the mobile terminal 11 receives the DIDcomm connection response transmitted from the VC issuing server 13 and passes the DIDcomm connection response to the SSI mobile agent 33.

The SSI mobile agent 33 decrypts the received message of the DIDcomm connection response with the private key of the mobile terminal 11 recorded in the recording unit 31 to extract the label, the DID, and the access information of the VC issuing server 13 from the DIDcomm connection response. The label, the DID, and the access information may be passed to and recorded in the recording unit 31 as appropriate.

Through the above-described processing, the access information including the DID and the public key of the connection partner used for the DIDcomm connection is exchanged between the mobile terminal 11 and the VC issuing server 13, and the DIDcomm connection, that is, the encrypted DIDcomm connection is established. The DIDcomm is an encrypted secure communication channel established over the SSI network 17.

Note that, in a case where the above-described past (existing) DIDcomm connection is reused, the label, the DID, and the access information of the VC issuing server 13 recorded in the recording unit 31 are also reused as the information regarding the past DIDcomm connection for communication over the DIDcomm connection as appropriate.

In this case, the VC issuing server 13 can also confirm that the DIDcomm connection with the mobile terminal 11 has been established from the recorded session information, connection information to be described later, or the like, and the DIDcomm connection with the mobile terminal 11 is reused. That is, the session management unit 42 reuses information regarding the DIDcomm connection such as the session information or the connection information to establish the DIDcomm connection with the mobile terminal 11.

After the DIDcomm connection is established, the mobile terminal 11 and the VC issuing server 13 communicate with each other over the DIDcomm.

Furthermore, when the DIDcomm connection is established between the mobile terminal 11 and the VC issuing server 13, the VC issuing server 13 executes the process of step S36 to update DIDcomm connection information.

That is, the session management unit 42 of the VC issuing server 13 holds, as the DIDcomm connection information, a list of a plurality of mobile terminals having the DIDcomm connection established with the VC issuing server 13 at this point.

In step S36, the session management unit 42 adds the mobile terminal 11 that has newly established the DIDcomm connection this time, more specifically, the address of the mobile terminal 11, to the held list to update the DIDcomm connection information (list).

Furthermore, at this time, the session management unit 42 generates connection information that is information regarding the DIDcomm connection between the mobile terminal 11 and the VC issuing server 13, passes the connection information to the recording unit 44 for recording. Note that, in a case where the connection information has already been recorded in the recording unit 44, the connection information is updated as appropriate in step S36. Alternatively, the connection information may be generated at the timing of step S38 to be described later or the like.

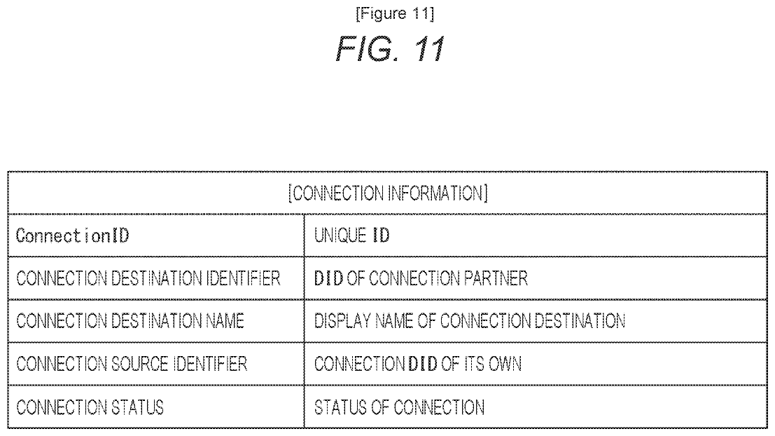

For example, the session management unit 42 generates connection information illustrated in FIG. 11 on the basis of the message of the DIDcomm connection request or the message of the DIDcomm connection response related to the DIDcomm connection established with the mobile terminal 11.

In this example, the connection information includes the ConnectionID that uniquely identifies the DIDcomm connection between the mobile terminal 11 and the VC issuing server 13, a connection destination identifier, a connection destination name, a connection source identifier, and a connection status.

The connection destination identifier and the connection destination name indicate a DID and a display name of the mobile terminal 11 (user) that is a connection destination of the DIDcomm connection as viewed from the VC issuing server 13. Therefore, in this example, the DID and the label of the mobile terminal 11 included in the DIDcomm connection request are used as they are as the connection destination identifier and the connection destination name.

Furthermore, the connection source identifier in the connection information indicates a connection source of the DIDcomm connection, that is, the DID of the VC issuing server 13 itself over the DIDcomm connection with the mobile terminal 11. Therefore, in this example, the DID of the VC issuing server 13 included in the DIDcomm connection response is used as it is as the connection source identifier.

Moreover, the connection status in the connection information indicates the current status of the DIDcomm connection such as connecting or not connecting (out of connection).

In step S65, the communication unit 34 of the mobile terminal 11 transmits a start request including the SessionID to the VC issuing server 13 over the DIDcomm connection.

For example, the SSI mobile agent 33 generates a start request that includes the SessionID in the invitation code read (received) in step S61 and requests the start of communication (processing) for issuing a VC over the DIDcomm connection, and passes the start request to the communication unit 34.

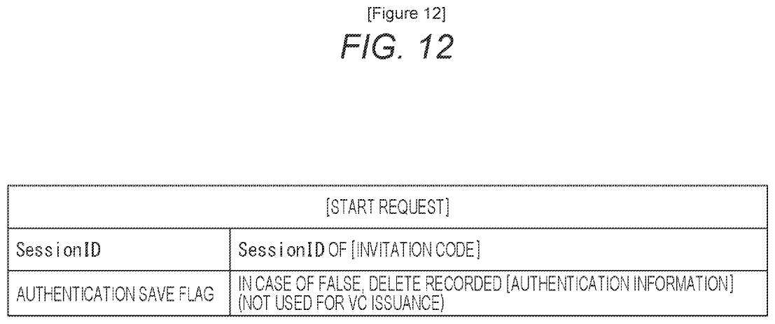

In this case, the SSI mobile agent 33 generates, for example, a start request illustrated in FIG. 12. Note that, in the example illustrated in FIG. 12, the start request includes the SessionID and an authentication save flag, and more specifically, the start request generated by the SSI mobile agent 33 when step S65 is executed does not include the authentication save flag.

As described later, the authentication save flag is flag information indicating whether or not the recorded authentication information for authentication of the user (mobile terminal 11) is deleted from the verification server 15.

Furthermore, when the start request is generated, the communication unit 34 transmits the start request passed from the SSI mobile agent 33 to the VC issuing server 13. At this time, the communication unit 34 transmits the start request to the address of the VC issuing server 13 indicated by the connection destination access information of the invitation code obtained in step S61.

Then, in step S37, the communication unit 41 of the VC issuing server 13 receives the start request transmitted from the mobile terminal 11.

It is therefore determined that, from the mobile terminal 11 that is the connection destination device of the DIDcomm connection that has read the invitation code, the SessionID included in the invitation code has been received.

In step S38, the session management unit 42 of the VC issuing server 13 adds the ConnectionID of the connection information to the session information and stores the session information in accordance with the received start request.

That is, the session management unit 42 confirms that the SessionID included in the received start request is the same as the SessionID included in the session information generated in step S32 and recorded in the recording unit 44.

Next, the session management unit 42 adds the ConnectionID of the connection information that uniquely identifies the currently active DIDcomm connection to the session information generated in step S32, and records the session information having the ConnectionID added thereto (included therein) in the recording unit 44.

Note that, in a case where the ConnectionID has already been recorded in the session information, the process of step S38 is skipped. Furthermore, as described above, the expiration time is set for the session information, and the session information that has passed the expiration time is considered invalid and deleted from the recording unit 44 by the session management unit 42.

The above-described processing allows, in the VC issuing server 13, the client ID, the SessionID, and the ConnectionID to be associated with each other by the session information.

For example, it is assumed that an invitation code request including a client ID “A01” is received in step

S31, an invitation code including a SessionID “S02” is transmitted in step S33, and a DIDcomm connection identified by a ConnectionID “C03” is established with the mobile terminal 11.

In such a case, in step S38, session information including the client ID “A01”, the SessionID “S02”, and the ConnectionID “C03” is obtained.

In other words, the client ID “A01”, the SessionID “S02”, and the ConnectionID “C03” are recorded in association with each other by the session management unit 42.

This allows the VC issuing server 13 to link the mobile terminal 11 that has transmitted the start request and the user management site application 12 that has requested the issuance of a VC together. Therefore, the VC issuing server 13 can identify of which user management site application 12 the user has read the invitation code among a plurality of user management site applications 12.

Attention is now shifted from the description of FIG. 4 to the description of FIG. 5, and in step S39, the SSI cloud agent 43 generates an SSI credential proposal for the connection destination that has transmitted the start request and is uniquely identified by the ConnectionID of the session information, that is, the mobile terminal 11.

For example, the SSI cloud agent 43 generates, as the SSI credential proposal, a VC in a format conforming to definition information set for each service provided by the user management site application 12 on the basis of the VC data (user information) received in step S31. The SSI cloud agent 43 passes the generated SSI credential proposal to the communication unit 41.

For example, in the definition information, information such as credential items to be included in a VC, a VC data structure, and the like are defined.

The SSI credential proposal (VC) includes, for example, personal information of the user included in the VC data (user information) such as the user ID as a credential item. Furthermore, the SSI credential proposal is signed by the private key of the VC issuing server 13, and has each credential item cryptographically verifiable.

In step S40, the communication unit 41 transmits the SSI credential proposal generated in step S39 to the mobile terminal 11 via the SSI mediator agent 22.

Note that, after the transmission of the SSI credential proposal, the VC issuing server 13 may notify the user management site application 12 of an event indicating that the SSI credential proposal has been made. This allows the user management site application 12 to notify (present) the user (mobile terminal 11) that the processing related to VC issuance has started.

In step S66, the communication unit 34 of the mobile terminal 11 receives the SSI credential proposal transmitted from the VC issuing server 13.

In step S67, the SSI mobile agent 33 passes the received SSI credential proposal to the display unit 35 to present (display) the SSI credential proposal to the user, so as to prompt the user to check the content of the SSI credential proposal. That is, confirmation (consent) is required that there be no error in the content of the proposed VC (SSI credential proposal) and whether or not to continue the processing of VC issuance as it is.

When the user operates the mobile terminal 11 to consent to continue the processing, the SSI mobile agent 33 generates a credential request that requests the issuance of a VC with the content of the SSI credential proposal and passes the credential request to the communication unit 34.

In step S68, the communication unit 34 transmits the credential request passed from the SSI mobile agent 33 to the VC issuing server 13 over the DIDcomm connection.

Then, in step S41, the communication unit 41 of the VC issuing server 13 receives the credential request transmitted from the mobile terminal 11.

In step S42, the SSI cloud agent 43 issues a VC (SSI credential) to the mobile terminal 11, that is, the user, in response to the credential request.

Specifically, for example, the SSI cloud agent 43 issues the SSI credential proposal generated in step S39 as it is as a final VC, and passes the final VC to the communication unit 41.

Furthermore, the SSI cloud agent 43 registers (records), in the SSI blockchain 21, information regarding the issued VC, such as the DID and the public key of the VC issuing server 13 over the DIDcomm connection with the mobile terminal 11, the definition information, and a revocation list.

In step S43, the communication unit 41 transmits the VC (SSI credential) issued in step S42 to the mobile terminal 11 via the SSI mediator agent 22.

Note that the VC issuing server 13 may notify, after the transmission of the VC, the user management site application 12 of an event indicating that the VC has been issued. This allows the user management site application 12 to notify (present) the user (mobile terminal 11) that the VC has been issued.

In step S69, the communication unit 34 of the mobile terminal 11 receives the VC transmitted from the VC issuing server 13.

Then, in step S70, the SSI mobile agent 33 passes the received VC to the recording unit 31, more specifically, a wallet in the recording unit 31 for recording.

Through the above-described processing, the VC is issued to the mobile terminal 11 by the VC issuing server 13, and the processing executed by the user management site application 12, the VC issuing server 13, and the mobile terminal 11 for VC issuance is brought to an end.

As described above, in a case where the mobile terminal 11 and the VC issuing server 13 perform communication over the DIDcomm connection, when the DIDcomm connection has already been established (in the past), the DIDcomm connection is reused. This eliminates the need for the user to perform the procedure of establishing a new connection every time the DIDcomm connection (login) is established, and it is therefore possible to implement the self-sovereign user authentication in a simpler manner.

Moreover, for the service providing system illustrated in FIG. 3, it is not necessary to implement the SSI protocol directly in the user management site application 12, and the mobile terminal 11 and the user management site application 12 can be linked (associated) with each other by the VC issuing server 13 using the session information. It is therefore possible to implement the self-sovereign user authentication with a simpler mechanism.

### <Description of Processing for Authentication Using SSI Certificate>

Next, a description will be given of processing that is executed when the user receives a service provided by the service site application 14.

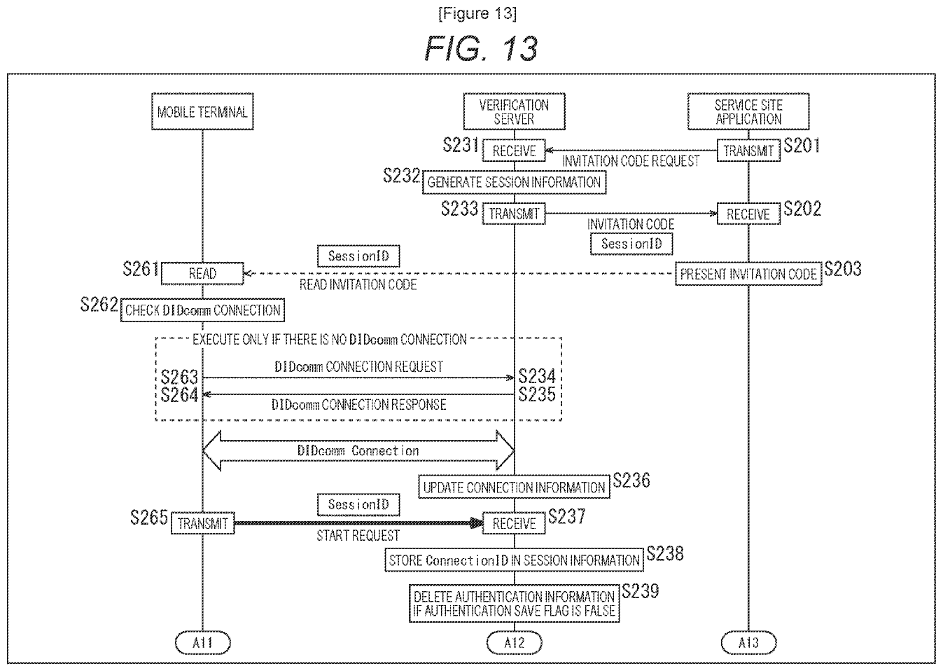

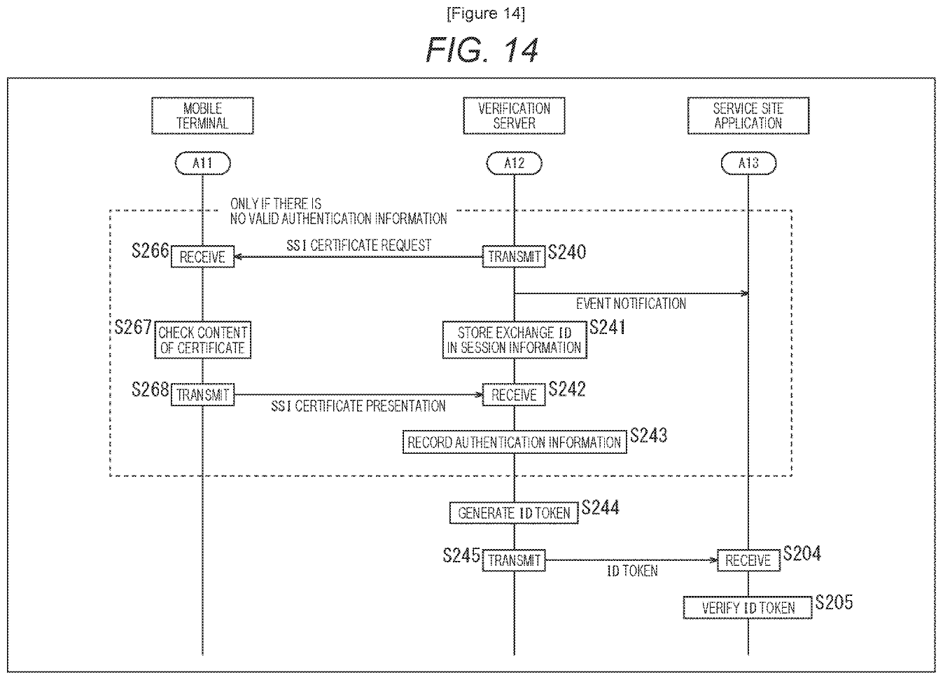

That is, a description will be given below of processing that is executed by the mobile terminal 11, the verification server 15, and the service site application 14 for authentication using the SSI certificate with reference to flowcharts illustrated in FIGS. 13 and 14. In particular, FIG. 14 illustrates the continuation of the flowchart illustrated in FIG. 13.

Furthermore, the processes of steps S201 to S203, steps S231 to S238, and steps S261 to S265 are similar to the processes of steps S12 to S14, steps S31 to S38, and steps S61 to S65 illustrated in FIG. 4, so that the processes will be briefly described below.

First, in order to log in to the service site run by the service site application 14, the mobile terminal 11 accesses the service site application 14 to cause the service site application 14 to open (display) a login page.

Then, in step S201, a service providing application of the service site application 14 transmits, to the verification server 15, an invitation code request that requests the issuance of an invitation code for establishing a DIDcomm connection for user authentication.

For example, the service site application 14 transmits the invitation code request illustrated in FIG. 6. This requests the verification server 15 to perform user authentication, more specifically, the verification of an SSI certificate generated from the VC possessed by the user.

Note that, in this case, the client ID, the client secret, and the response destination address included in the invitation code request are assumed to be of the service site application 14.

In step S231, the communication unit 51 of the verification server 15 receives the invitation code request transmitted from the service site application 14.

In step S232, the session management unit 52 of the verification server 15 generates an invitation code and session information on the basis of the received invitation code request.

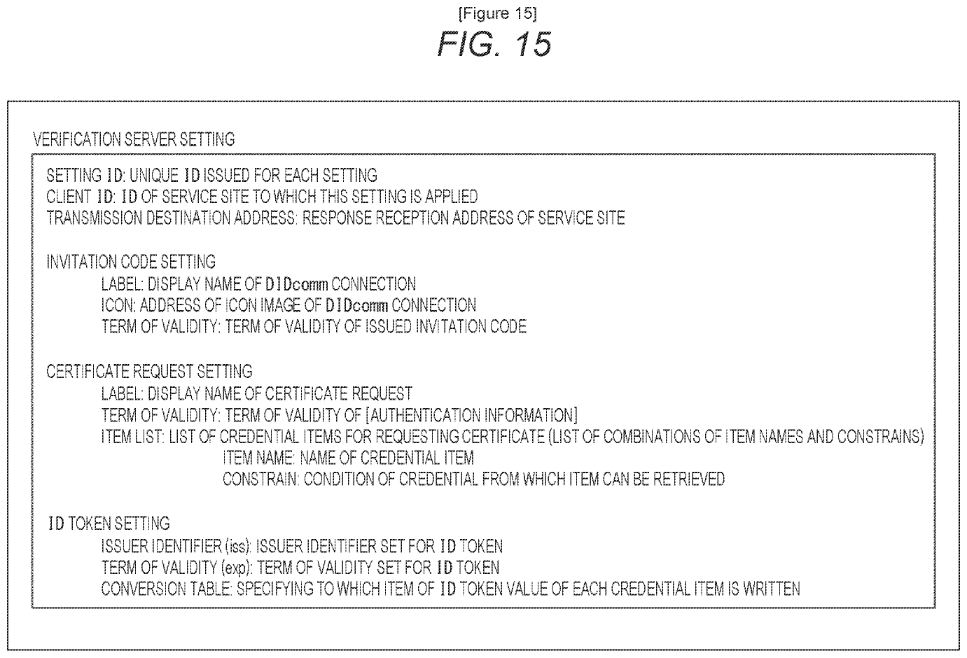

For example, the verification server 15 assigns a unique client ID to each service site application 14 serving as a client, and the recording unit 55 of the verification server 15 has setting information, for example, as illustrated in FIG. 15, prerecorded therein for each client.

In the example illustrated in FIG. 15, the setting information includes a setting ID, a client ID, a transmission destination address, an invitation code setting, a certificate request setting, and an ID token setting as setting items.

The setting ID is a unique ID issued for each setting information of the client (service site application 14). Furthermore, the client ID is an ID (identifier) indicating the service site application 14 to which the setting information is applied, and this client ID is included in the invitation code request.

The transmission destination address indicates a response reception address of the service site application 14 (client), that is, the client. More specifically, when the invitation code request is generated, the transmission destination address is made to be a part of the response destination address included in the invitation code request. This prevents information from being leaked to the outside due to unauthorized addressing.

The invitation code setting includes, as setting items, a label indicating a display name of the DIDcomm connection with the verification server 15, an address of an icon image representing the DIDcomm connection, and information indicating a term of validity of the invitation code issued for the DIDcomm connection.

The certificate request setting includes, as setting items, a label indicating a display name of an SSI certificate request (certificate request), a term of validity of authentication information regarding an SSI certificate (user) to be described later, and an item list of the SSI certificate.

The item list is a list of combinations of an item name and a constraint of a credential item requested to be certified, that is, a credential item to be included in the SSI certificate.

Specifically, the item list includes information indicating an item name of a credential item requested to be certified and information indicating a condition, that is, a constraint, under which each credential item can be extracted from a credential (VC). The condition (constraint) given herein is, for example, a condition related to an extraction source (output source) of a credential item or the like, such as a condition under which a predetermined credential item needs to be extracted from a driver's license or an insurance card serving as a VC.

Furthermore, the ID token setting includes, as setting items, an issuer identifier that is set in the ID token, a term of validity that is set in the ID token, and a conversion table that is used for conversion of the SSI certificate into the ID token.

The verification server 15 can make an individual setting as setting information for each client ID (client).

Furthermore, when executing an API of the verification server 15 such as a process of making a response to the invitation code request, the verification server 15 needs to transmit the client ID and the client secret issued for each client ID. Furthermore, unless both the client ID and the client secret are correct, the execution of the requested API is not permitted.

Therefore, the session management unit 52 authenticates the service site application 14 on the basis of the client ID and the client secret included in the invitation code request from the service site application 14 and the setting information recorded in the recording unit 55.

After the authentication, the session management unit 52 generates an invitation code including a SessionID for the service site application 14 that is a transmission source device of the invitation code request.

That is, the session management unit 52 generates, for example, the invitation code illustrated in FIG. 8 on the basis of the invitation code setting of the setting information recorded in the recording unit 55, in a manner similarly to the case of step S32 illustrated in FIG. 4.

Furthermore, the session management unit 52 also generates, for example, the session information illustrated in FIG. 10 on the basis of the setting information recorded in the recording unit 55.

For example, the session management unit 52 stores the client ID included in the invitation code request received in step S231 as it is in the session information, and sets the current date as the creation date of the session information. Furthermore, the session management unit 52 stores a value obtained by adding the term of validity in the invitation code setting in the setting information recorded in the recording unit 55 to the current date (creation date) in the session information as the expiration time of the session information.

Note that, at this point, the session information includes neither the ConnectionID nor the exchange ID.

After the generation of the invitation code and the session information as described above, the session management unit 52 passes the invitation code to the communication unit 51 via the SSI cloud agent 53 and passes the session information to the recording unit 55 for recording.

Returning to the description of the flowchart in FIG. 13, in step S233, the communication unit 51 of the verification server 15 transmits the invitation code generated in step S232 to the service site application 14.

Then, in step S202, the service site application 14 receives the invitation code including the SessionID transmitted by the verification server 15.

In step S203, the service site application 14 presents the received invitation code to the mobile terminal 11, that is, the user.

In step S261, the SSI mobile agent 33 of the mobile terminal 11 controls the camera 32 and the like as appropriate to read the invitation code presented by the service site application 14. Note that how to read the invitation code may be any method such as reading using a barcode or reading by means of wireless communication in a manner similar to the case of step S61 in FIG. 4.

In step S262, the SSI mobile agent 33 of the mobile terminal 11 refers to, as appropriate, the information recorded in the recording unit 31 to check the content of the read invitation code, so as to confirm (identify) whether or not the DIDcomm connection with the verification server 15 has already been established.

For example, in step S262, in a manner similar to the case of step S62 in FIG. 4, it is confirmed whether or not the DIDcomm connection has been established on the basis of the connection destination access information, the connection destination name, and the like included in the invitation code.

In a case where it is confirmed (determined) in step S262 that the DIDcomm connection has been established, the processes of steps S263 and S264 are skipped, and the processing proceeds to step S265 thereafter.

At this time, the SSI mobile agent 33 reuses the information regarding a past DIDcomm connection with the verification server 15, such as the ConnectionID recorded in the recording unit 31, the label, the DID, and the access information of the verification server 15 to establish the DIDcomm connection with the verification server 15. That is, the already established DIDcomm connection is reused.

In this case, the verification server 15 also reuses the DIDcomm connection with the mobile terminal 11. That is, the session management unit 52 reuses the information regarding the DIDcomm connection such as the session information or the connection information to establish the DIDcomm connection with the mobile terminal 11.

On the other hand, in a case where it is confirmed in step S262 that the DIDcomm connection has not been established, the processes of steps S263 and S264 are executed to establish the DIDcomm connection. At this time, in the verification server 15, the processes of steps S234 and S235 are executed in response to the processes of steps S263 and S264.

Specifically, the display unit 35 displays a connection confirmation screen for establishing the DIDcomm connection with the verification server 15 on the basis of the invitation code. When the user confirms the displayed connection confirmation screen and presses a confirmation button by operating the mobile terminal 11, the process of step S263 is executed.

In step S263, the SSI mobile agent 33 reads, as appropriate, information regarding the mobile terminal 11 (user) recorded in the recording unit 31, generates a DIDcomm connection request from the read information, and causes the communication unit 34 to transmit the DIDcomm connection request.

For example, the DIDcomm connection request includes the label, the DID, and the access information of the mobile terminal 11 in a manner similar to the case of step S63 in FIG. 4.

The communication unit 34 transmits the DIDcomm connection request generated by the SSI mobile agent 33 to the verification server 15 over the SSI network 17. Then, in step S234, the communication unit 51 of the verification server 15 receives the DIDcomm connection request transmitted from the mobile terminal 11.

Then, the session management unit 52 decrypts the received message of the DIDcomm connection request with the private key of the verification server 15 recorded in the recording unit 55 to extract the label, the DID, and the access information of the mobile terminal 11 from the DIDcomm connection request. The label, the DID, and the access information may be passed to and recorded in the recording unit 55 as appropriate.

Furthermore, the session management unit 52 reads, as appropriate, necessary information from the recording unit 55 in response to the DIDcomm connection request, and generates a DIDcomm connection response that is a massage including the label, the DID, and the access information of the verification server 15 and is encrypted with the access information of the mobile terminal 11.

In step S235, the communication unit 51 transmits the DIDcomm connection response generated by the session management unit 52 to the mobile terminal 11 over the SSI network 17.

Then, in step S264, the communication unit 34 of the mobile terminal 11 receives the DIDcomm connection response transmitted from the verification server 15 and passes the DIDcomm connection response to the SSI mobile agent 33.

The SSI mobile agent 33 decrypts the received message of the DIDcomm connection response with the private key of the mobile terminal 11 recorded in the recording unit 31 to extract the label, the DID, and the access information of the verification server 15 from the DIDcomm connection response. The label, the DID, and the access information may be passed to and recorded in the recording unit 31 as appropriate.

Through the above-described processing, the DIDcomm connection is established between the mobile terminal 11 and the verification server 15. After the DIDcomm connection is established, the mobile terminal 11 and the verification server 15 communicate with each other over the DIDcomm.

Furthermore, when the DIDcomm connection is established between the mobile terminal 11 and the verification server 15, the verification server 15 executes the process of step S236 to update DIDcomm connection information.

That is, in step S236, in a manner similar to the case of step S36 in FIG. 4, the session management unit 52 adds the mobile terminal 11 to a list of a plurality of mobile terminals having the DIDcomm connection established with the verification server 15 at this point, and holds the updated DIDcomm connection information.

Furthermore, at this time, the session management unit 52 generates connection information that is information regarding the DIDcomm connection between the mobile terminal 11 and the verification server 15, passes the connection information to the recording unit 55 for recording.

In this case, for example, the connection information illustrated in FIG. 11 is generated, and the connection destination identifier and the connection source identifier in the connection information correspond to the DID of the mobile terminal 11 and the DID of the verification server 15, respectively.

In step S265, the communication unit 34 of the mobile terminal 11 transmits a start request including the SessionID to the verification server 15 over the DIDcomm connection.

For example, the SSI mobile agent 33 generates a start request that includes the SessionID in the invitation code read in step S261 and requests the start of communication (processing) for user authentication using an SSI certificate over the DIDcomm connection, and passes the start request to the communication unit 34.

For example, the SSI mobile agent 33 generates the start request illustrated in FIG. 12. Note that, unlike when step S65 described above is executed, in step S265, a start request including the SessionID and the authentication save flag is generated. In this case, the user can set the authentication save flag to “true” or “false”.

In a case where the authentication save flag is set to “true”, in the verification server 15, user authentication information to be described later is recorded as it is without being deleted, and in a case where the authentication save flag is set to “false”, in the verification server 15, the user authentication information is deleted. That is, the authentication save flag set to “false” is flag information indicating a request to delete the authentication information.

For example, the user sets the authentication save flag to “false” when the user wants to update (reset) information regarding his/her login.

Furthermore, when the start request is passed from the SSI mobile agent 33, the communication unit 34 transmits the start request to the verification server 15. In step S265, the start request is transmitted to the address of the verification server 15 indicated by the connection destination access information of the invitation code obtained in step S261.

Then, in step S237, the communication unit 51 of the verification server 15 receives the start request transmitted from the mobile terminal 11. It is therefore determined that, from the mobile terminal 11 that is the connection destination device of the DIDcomm connection that has read the invitation code, the SessionID included in the invitation code has been received.

In step S238, the session management unit 52 of the verification server 15 adds the ConnectionID of the connection information to the session information and stores the session information in accordance with the received start request.

That is, the session management unit 52 confirms that the SessionID included in the received start request is the same as the SessionID included in the session information generated in step S232 and recorded in the recording unit 55.

Next, the session management unit 52 adds the ConnectionID of the connection information that uniquely identifies the currently active DIDcomm connection with the mobile terminal 11 to the session information generated in step S232, and records the session information having the ConnectionID added thereto (included) in the recording unit 55.

In other words, the session management unit 52 records, in the recording unit 55, the client ID that identifies the service site application 14 that is the transmission source device of the invitation code request, the SessionID received from the mobile terminal 11 that is the connection destination device that has read the invitation code, and the ConnectionID used for the DIDcomm connection with the mobile terminal 11 with the client ID, the SessionID, and the ConnectionID associated with each other.

Note that, in a case where the ConnectionID has already been recorded in the session information, the process of step S238 is skipped. Furthermore, in a case where the expiration time of the session information has passed, the session information is considered invalid and deleted by the session management unit 52.

The above-described processing allows, in the verification server 15, the client ID, the SessionID, and the ConnectionID to be associated with each other by the session information.

In step S239, in a case where the authentication save flag is set to “false” in the start request received in step S237 and the authentication information has been recorded (stored) in the recording unit 55, the SSI cloud agent 53 of the verification server 15 deletes the authentication information.

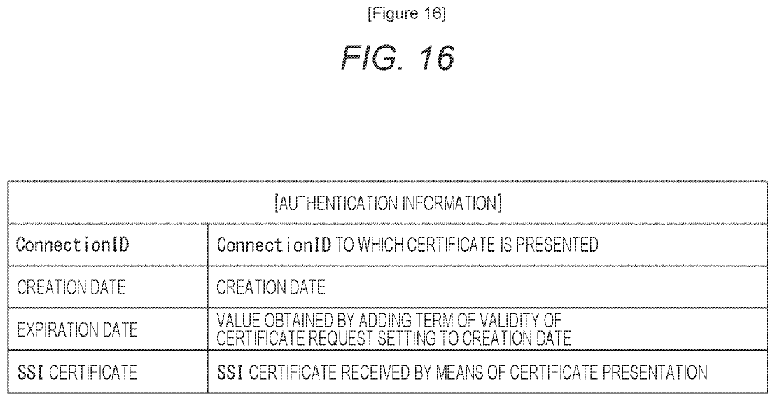

For example, in a case where the mobile terminal 11 (user) that is a connection partner of the DIDcomm connection has been authenticated, as information regarding the authentication (user authentication), the authentication information illustrated in FIG. 16 has been recorded in the recording unit 55.

In the example illustrated in FIG. 16, the authentication information includes a ConnectionID, a creation date, an expiration time, and an SSI certificate.

Here, the SSI certificate included in the authentication information is presented from the mobile terminal 11 (user) for user authentication, and the ConnectionID included in the authentication information is a ConnectionID indicating the DIDcomm connection with the mobile terminal 11 from which the SSI certificate is presented.

In a case where the start request in which the authentication save flag is set to “false” is received, that is, in a case where there is a request to delete the authentication information by means of the authentication save flag, the SSI cloud agent 53 searches for the corresponding authentication information.

Specifically, the SSI cloud agent 53 searches the recording unit 55 for the authentication information including the same ConnectionID as the ConnectionID included in the session information regarding the DIDcomm connection with the mobile terminal 11.

Then, the SSI cloud agent 53 deletes, from the recording unit 55, the authentication information obtained as a result of the search. Note that, in a case where there is no authentication information including the same ConnectionID as the ConnectionID included in the session information in the recording unit 55, or in a case where the authentication save flag is “true”, the process of step S239 is skipped.

Attention is now shifted from the description of FIG. 13 to the description of FIG. 14, and in a case where the authentication information including the same ConnectionID as the ConnectionID included in the session information regarding the DIDcomm connection with the mobile terminal 11 is not recorded in the recording unit 55, that is, in a case where there is no valid authentication information, the processes of subsequent steps S240 to S243 are executed. For example, in a case where the process of step S239 is executed, it is determined that there is no valid authentication information. Furthermore, in a case where there is no valid authentication information, the processes of steps S266 to S268 are executed in the mobile terminal 11.

In step S240, the communication unit 51 of the verification server 15 transmits an SSI certificate request that requests the presentation of an SSI certificate for user authentication to the mobile terminal 11 over the DIDcomm connection, that is, via the SSI mediator agent 22.

For example, the SSI cloud agent 53 generates an SSI certificate request including the item list of the certificate request setting in the setting information of the verification server 15 illustrated in FIG. 15, issues an exchange ID unique to the SSI certificate request, and passes the SSI certificate request and the exchange ID to the communication unit 51.

The communication unit 51 transmits the SSI certificate request and the exchange ID passed from the SSI cloud agent 53 to the mobile terminal 11. At this time, the transmission destination of the SSI certificate request and the exchange ID is a connection destination identified by the ConnectionID of the session information indicating the DIDcomm connection, that is, the mobile terminal 11 identified by the ConnectionID.

The transmission of the SSI certificate request corresponds to that the SSI cloud agent 53 requests the mobile terminal 11 to present the SSI certificate.

Note that, after the transmission of the SSI certificate request, the verification server 15 may notify the service site application 14 of an event indicating that the SSI certificate request has been made. Then, the service site application 14 can notify (present) the user (mobile terminal 11) that the SSI certificate request, that is, the user authentication processing, has started. At this time, the notification destination of the start of the user authentication processing is not limited to the mobile terminal 11, and may be another terminal different from the mobile terminal 11, such as a Desktop application. As an example, for example, when the event notification is made with a QR code (registered trademark) or the like displayed as the invitation code on the login screen, the display of the invitation code disappears, and a message indicating that processing is ongoing can be displayed.

In step S241, the SSI cloud agent 53 adds the exchange ID issued for the SSI certificate request to the session information regarding the DIDcomm connection with the mobile terminal 11 recorded in the recording unit 55 to update the session information.

Furthermore, when the process of step S240 is executed, the processes of steps S266 to S268 are executed in the mobile terminal 11.

That is, in step S266, the communication unit 34 of the mobile terminal 11 receives the SSI certificate request and the exchange ID transmitted from the verification server 15.

In step S267, the SSI mobile agent 33 generates an SSI certificate in accordance with the content of the received SSI certificate request, and passes the generated SSI certificate to the display unit 35 to display the SSI certificate, so as to cause the user to confirm the content of the SSI certificate.

That is, the SSI mobile agent 33 generates the SSI certificate on the basis of the item list included in the received SSI certificate request and the issued VC of the user recorded in the recording unit 31 (wallet). At this time, a credential item having an item name indicated by the item list is extracted from the VC satisfying a condition (constraint) indicated by the item list, and the SSI certificate including the extracted one or a plurality of credential items is generated.

Note that, in a case where there is a plurality of VCs available for the generation of the SSI certificate, the SSI mobile agent 33 may cause the display unit 35 to display a list of the available (selectable) VCs, and cause the user to designate (select) a VC to be used for the generation of the SSI certificate.

Furthermore, the SSI mobile agent 33 causes the display unit 35 to present (display) the generated SSI certificate to prompt the user to confirm the content of the SSI certificate. That is, confirmation (consent) is required whether or not to continue the subsequent processing with the content of the presented SSI certificate.

When the user operates the mobile terminal 11 to consent to continue the processing, the SSI mobile agent 33 passes, to the communication unit 34, the generated SSI certificate, and the exchange ID received in step S266.

In step S268, the communication unit 34 transmits the SSI certificate and the exchange ID passed from the SSI mobile agent 33 to the verification server 15 over the DIDcomm connection.

Then, in step S242, the communication unit 51 of the verification server 15 receives the SSI certificate and the exchange ID transmitted from the mobile terminal 11.

In step S243, the SSI cloud agent 53 of the verification server 15 generates authentication information in accordance with the received SSI certificate and records the authentication information in the recording unit 55.

Specifically, the SSI cloud agent 53 first confirms that the exchange ID received in step S242 is the same as the exchange ID added to the session information in step S241. It is therefore confirmed that the SSI certificate received in step S242 is from the mobile terminal 11 to which the verification server 15 has requested the presentation of the SSI certificate.

Next, the SSI cloud agent 53 verifies the received SSI certificate on the basis of the SSI certificate received over the DIDcomm connection and the information regarding the VC such as the definition information and the revocation list registered in the SSI blockchain 21.

Moreover, the SSI cloud agent 53 generates the authentication information illustrated in FIG. 16 on the basis of the received SSI certificate, the session information regarding the DIDcomm connection with the mobile terminal 11, and the certificate request setting in the setting information for each client (service site application 14) recorded in the recording unit 55.

For example, the SSI cloud agent 53 stores, in the authentication information, the received SSI certificate and the ConnectionID included in the session information regarding the DIDcomm connection with the mobile terminal 11. Furthermore, the SSI cloud agent 53 stores the current date as a creation date of the authentication information in the authentication information, and stores a value obtained by adding the term of validity in the certificate request setting in the setting information recorded in the recording unit 55 to the creation date in the authentication information as an expiration time of the authentication information.

As a result, the authentication information indicating the DIDcomm connection for which the verification of the SSI certificate is completed has been obtained. The SSI cloud agent 53 passes the authentication information thus obtained to the recording unit 55 for recording.

Note that in a case where the authentication information becomes invalid after the expiration time or a case where a start request in which the authentication save flag is set to “false” is received, the authentication information is deleted by the SSI cloud agent 53. Furthermore, in a case where the session information regarding the DIDcomm connection with the mobile terminal 11 is already invalid, the process of step S243 is skipped.

As described above, in a case where no valid authentication information is recorded in the recording unit 55, the verification server 15 executes the processes of steps S240 to S243, and the mobile terminal 11 executes the processes of steps S266 to S268. Then, thereafter, the process of step S244 is executed to generate an ID token.

On the other hand, in a case where the authentication information including the same ConnectionID as the ConnectionID included in the session information regarding the DIDcomm connection with the mobile terminal 11 has already been recorded in the recording unit 55, that is, in a case where there is valid authentication information, the SSI certificate request is not transmitted, and the ID token is immediately generated. That is, the processes of steps S240 to S243 and the processes of steps S266 to S268 are skipped, and the process of step S244 is immediately executed.

In a case where a valid authentication information has already been recorded in the recording unit 55, the SSI cloud agent 53 can determine that, on the basis of the authentication information, the SSI certificate has been presented in the past by the mobile terminal 11 that is the connection destination of the DIDcomm connection and the SSI certificate has been verified.

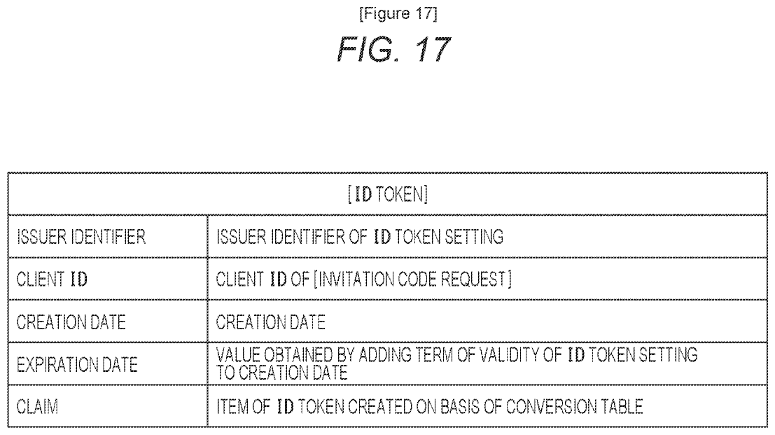

In step S244, the ID token generation unit 54 generates, for example, an ID token illustrated in FIG. 17 on the basis of the SSI certificate of the mobile terminal 11 and the ID token setting in the setting information illustrated in FIG. 15 recorded in the recording unit 55.

In the example illustrated in FIG. 17, the ID token includes an issuer identifier, a client ID, a creation date, an expiration time, and a claim.

The issuer identifier of the ID token corresponds to the issuer identifier in the ID token setting, and in this example, an identifier indicating the verification server 15 is stored in the ID token as the issuer identifier.

Furthermore, the client ID corresponds to the client ID included in the invitation code request received in step S231. The creation date of the ID token corresponds to the current date when the process of step S244 is executed, and a value (date) obtained by adding the term of validity in the ID token setting to the current date corresponds to the expiration time of the ID token.

Moreover, the claim included in the ID token corresponds to a value of a credential item extracted from the SSI certificate by means of the conversion table in the ID token setting.

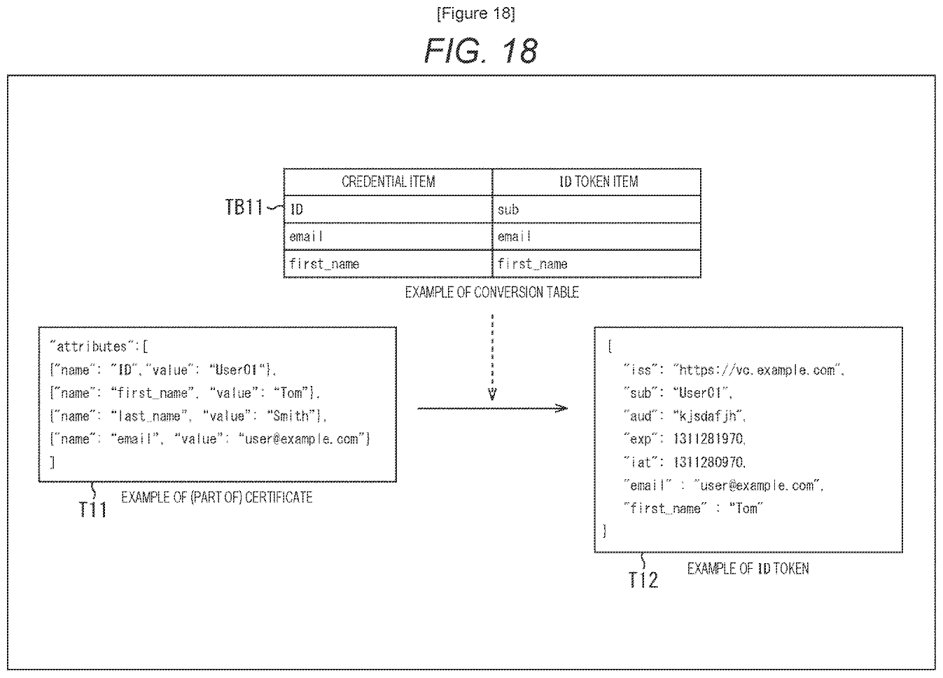

Here, a specific example of how to generate the ID token will be described with reference to FIG. 18.

In this example, an SSI certificate T11 is converted into an ID token T12 using a conversion table TB11.

The SSI certificate T11 includes, as an item name “name” of each credential item, “ID” indicating a user ID, “first_name” indicating a first name of the user, “last_name” indicating a last_name of the user, and “email” indicating an email address of the user. Furthermore, the SSI certificate T11 includes “User01”, “Tom”, “Smith”, and “user@example.com” as values “value” of the credential items.

On the other hand, the ID token T12 includes “iss”, “sub”, “aud”, “exp”, “iat”, “email”, and “first_name” as items of the ID token. In this example, the items have their respective values of “https://vc.example.com”, “User01”, “kjsdafjh”, “1311281970”, “1311280970”, “user@example.com”, and “Tom”.

Furthermore, the conversion table TB11 is a table specifying that the values of the item names “ID”, “email”, and “first name” in the SSI certificate are written to the items “sub”, “email”, and “first name” of the ID token.

Such a conversion table TB11 is defined for each client ID by the setting information of the verification server 15.

In this example, the ID token generation unit 54 sets the value of the issuer identifier of the ID token setting in the setting information illustrated in FIG. 15 as the value of the item “iss” of the ID token T12.

Furthermore, the ID token generation unit 54 stores, on the basis of the conversion table TB11, the values of the item names “ID”, “email”, and “first_name” in the SSI certificate T11 as they are as the values of the items “sub”, “email”, and “first_name” of the ID token T12.

The values of the items “sub”, “email”, and “first_name” of the ID token T12 correspond to the value of the claim of the ID token in the example illustrated in FIG. 17.

The ID token generation unit 54 stores the client ID in the setting information illustrated in FIG. 15 as the value of the item “aud” of the ID token T12, and stores the current date as the value of the item “iat” of the ID token T12. Moreover, the ID token generation unit 54 stores an expiration time obtained by adding the term of validity of the ID token setting in the setting information illustrated in FIG. 15 to the value of the item “iat” (current date) as the value of the item “exp” of the ID token T12.

Through the above-described processing, the SSI certificate used over the SSI network 17 is converted into an ID token that is a certificate different in format from the SSI certificate.

Returning to the description of FIG. 14, the ID token generation unit 54 passes the generated ID token to the communication unit 51.

In step S245, the communication unit 51 of the verification server 15 transmits the ID token passed from the ID token generation unit 54 to the service site application 14. More specifically, the invitation code request including the same client ID as the client ID of the session information and received in step S231 is referred to, and the ID token is transmitted to the response destination address included in the invitation code request.

In step S204, the service site application 14 receives the ID token transmitted from the verification server 15.

Then, in step S205, the service site application 14 verifies the received ID token.

For example, a digital signature generated by the ID token generation unit 54 on the basis of the ID token is attached to the ID token, and the service site application 14 verifies (confirms) the validity of the ID token by verifying the digital signature.

A possible method to verify the ID token includes a method to cause the service site application 14 to receive a public key for the digital signature in advance and verify the digital signature using the public key.

Furthermore, for example, the service site application 14 may transmit the ID token to a verification API provided by the verification server 15 and receive a verification result and a result of decoding the ID token from the verification server 15.

Moreover, the service site application 14 confirms that the ID token is valid by confirming the client ID and the expiration time included in the ID token.

Successful verification of the validity of the ID token corresponds to the end of user authentication, and as a result, the login of the user to the service site is completed.

When the login is completed, the service site application 14 transmits (presents), as appropriate, the ID token to the resource server 16 for providing a service to the user, so as to have access to data managed by the resource server 16 or the like.

Through the above-described processing, the user authentication using the SSI certificate is completed, and the processing executed by the mobile terminal 11, the verification server 15, and the service site application 14 for the user authentication is brought to an end.

As described above, in a case where the mobile terminal 11 and the verification server 15 communicate with each other over the DIDcomm connection, when the DIDcomm connection has already been established, the DIDcomm connection is reused. This eliminates the need for the user to perform the procedure of establishing a new connection every time the DIDcomm connection is established, and it is therefore possible to implement the self-sovereign user authentication in a simpler manner.

In addition, in the service providing system illustrated in FIG. 3, it is not necessary to implement the SSI protocol directly in the service site application 14, and the service site application 14 can use a widely used ID token as it is. Furthermore, the verification server 15 can link the mobile terminal 11 and the service site application 14 together using the session information. It is therefore possible to implement the self-sovereign user authentication with a simpler mechanism, that is, with a minimum system change.

### <Application Example of Present Technology>

Here, a specific application example of the above-described present technology will be described.

First, an example where the VC of the present technology is used as an electronic voucher for a product or the like will be described.

For example, when a limited product is sold by raffle sale, the voucher can be electronically issued.

The user accesses a preorder site (user management site application 12) for the purchase of the product using the smartphone (mobile terminal 11) and executes a raffle application. As a result, in a case of winning a raffle, a button for obtaining an invitation code appears on the screen. When the user presses this button, a VC certifying the winning result is issued as an electronic voucher to a mobile agent application (mobile terminal 11).

After a release date for the product, when the user comes to a store for purchasing the product, the user reads a QR code (registered trademark) displayed at the store front using the mobile agent application (mobile terminal 11). As a result, it is electronically proved that the user is the winner and can purchase the limited sale product.

Since the voucher (VC) is electronically issued to the wallet of the winner, it is difficult to resell the voucher (VC) to another person. Furthermore, it is not necessary to connect, when using the voucher, to a server of the raffle site (preorder site) that is the issuing source, and even in a case where connection to the server cannot be established, a case where the server is down, or a case where data on the server is lost, the right of the winner can be proved.

Furthermore, the present technology is also applicable to a vaccination certificate or the like.

That is, for example, a local government sends a QR code (registered trademark) including an invitation code to a vaccine recipient among residents by e-mail or mail. The user who is the vaccine recipient reads the invitation code with the mobile agent application (mobile terminal 11), so that an appointment card VC including information such as name, date of birth, gender, address, contact information, hospital name, and date and time of vaccination.

At a later date, the user scans an NFC port installed in the hospital with the mobile agent application to present the certificate by means of the appointment card VC. Upon receipt of information included in the appointment card VC, the hospital links the information with a patient database. Then, when the hospital confirms that the hospital name and the date and time of vaccination are correct, the user can take the vaccination.

After the completion of the vaccination, the user scans the NFC port installed in the hospital again with the mobile agent application, so that a vaccination certificate VC including information such as name, date of birth, gender, hospital name, doctor name, vaccination date, details of vaccination, and serial number is issued. Since the hospital identifies the ID of the patient (user) when the appointment card VC is first received, when scanning is performed using the same mobile agent application (mobile terminal 11), the hospital can immediately issue the vaccination certificate VC for the user.

Thereafter, when the user reads a QR code (registered trademark) displayed in a nearby restaurant using the mobile agent application (mobile terminal 11), the certificate is presented by means of the vaccination certificate VC to allow the user who have had a vaccination within the last three months to receive a service such as a discount. At this time, since only the vaccination date of the vaccination certificate VC is requested to be certified in the restaurant, the user need not present other personal information.

Furthermore, for example, at a later date, in a case where there is a request at the time of entry, the user can present the certificate using the vaccination certificate VC by reading a QR code (registered trademark) at a quarantine gate using the mobile agent application (mobile terminal 11).

### <Configuration Example of Computer>

Note that, the above-described series of processing may be executed by hardware or by software. In a case where the series of processing is executed by the software, a program constituting the software is installed on a computer. Here, examples of the computer include a computer incorporated in dedicated hardware, and for example, a general-purpose personal computer capable of executing various functions by installing various programs.

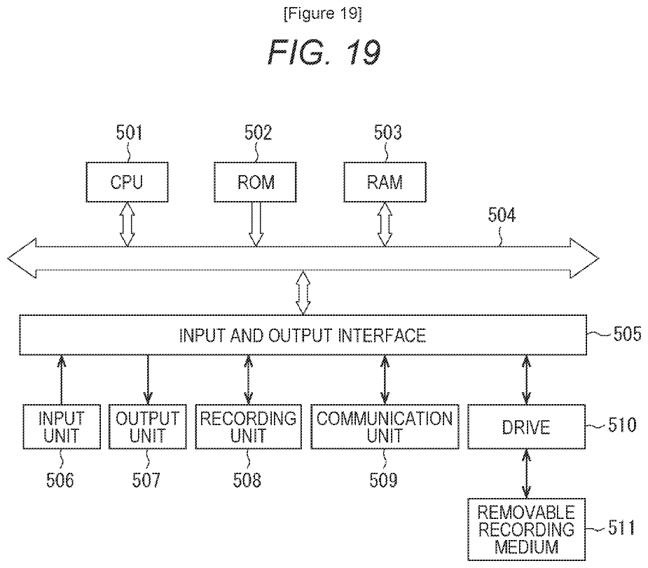

FIG. 19 is a block diagram illustrating a configuration example of the hardware of the computer that executes the above-described series of processing in accordance with the program.

In the computer, a CPU 501, a read only memory (ROM) 502, and a random access memory (RAM) 503 are mutually connected over a bus 504.

Moreover, an input and output interface 505 is connected to the bus 504. An input unit 506, an output unit 507, a recording unit 508, a communication unit 509, and a drive 510 are connected to the input and output interface 505.

The input unit 506 includes a keyboard, a mouse, a microphone, an imaging element, and the like. The output unit 507 includes a display, a speaker, and the like. The recording unit 508 includes a hard disk, a non-volatile memory, and the like. The communication unit 509 includes a network interface and the like. The drive 510 drives a removable recording medium 511 such as a magnetic disk, an optical disc, a magneto-optical disk, or a semiconductor memory.

In the computer configured as described above, the CPU 501 loads, for example, a program recorded in the recording unit 508 into the RAM 503 via the input and output interface 505 and the bus 504, and executes the program, so as to execute the above-described series of processing.

The program executed by the computer (CPU 501) can be provided by being recorded on the removable recording medium 511 as a package medium, or the like, for example. Furthermore, the program can be provided via a wired or wireless transmission medium such as a local area network, the Internet, or digital satellite broadcasting.

In the computer, the program can be installed on the recording unit 508 via the input and output interface 505 by mounting the removable recording medium 511 to the drive 510. Furthermore, the program can be received by the communication unit 509 via the wired or wireless transmission medium to be installed on the recording unit 508. In addition, the program can be installed in the ROM 502 or the recording unit 508 in advance.

Note that the program executed by the computer may be a program for processing executed in time series in the order described in the present description, or a program for processing executed in parallel or at a necessary timing such as when a call is made.

Furthermore, the embodiment of the present technology is not limited to the above-described embodiment, and various modifications are possible without departing from the scope of the present technology.

For example, the present technology may be configured as cloud computing in which one function is shared by a plurality of devices over the network to process together.

Furthermore, each of the steps in the flowcharts described above can be executed by one device or executed by a plurality of devices in a shared manner.

Moreover, in a case where a plurality of processes is included in one step, the plurality of processes included in one step can be executed by one device or by a plurality of devices in a shared manner.

Moreover, the present technology may also have a following configuration.
(1)
An information processing device including:
a session management unit that generates, for a transmission source device of an invitation code request for a DIDcomm connection, an invitation code including a session ID that identifies the DIDcomm connection, and performs control to record the session ID received over the DIDcomm connection from a connection destination device that has read the invitation code and a client ID that identifies the transmission source device included in the invitation code request with the session ID and the client ID associated with each other; and
a communication unit that communicates with the connection destination device over the DIDcomm connection, in which
in a case where the DIDcomm connection with the connection destination device has already been established, the session management unit reuses the DIDcomm connection with the connection destination device.
(2)
The information processing device according to (1), in which
the session management unit performs control to record the session ID, the client ID, and a connection ID used for the DIDcomm connection with the connection destination device with the session ID, the client ID, and the connection ID associated with each other.
(3)
The information processing device according to (1) or (2), further including:
a certificate verification unit that verifies a certificate generated on the basis of a VC in a case where the certificate is received from the connection destination device over the DIDcomm connection; and
a generation unit that converts the certificate into another certificate different in format from the certificate.
(4)
The information processing device according to (3), in which
the another certificate includes an ID token.
(5)
The information processing device according to (3) or (4), in which
the generation unit converts the certificate into the another certificate on the basis of a prerecorded conversion table.
(6)
The information processing device according to any one of (3) to (5), in which
the communication unit transmits the another certificate to the transmission source device.
(7)
The information processing device according to any one of (3) to (6), in which
the certificate verification unit generates authentication information including a connection ID used for the DIDcomm connection with the connection destination device and the certificate and performs control to record the authentication information.
(8)
The information processing device according to (7), in which
in a case where the authentication information has not been recorded, the certificate verification unit requests the connection destination device to present the certificate.
(9)
The information processing device according to (7) or (8), in which
in a case where there is a request to delete the authentication information from the connection destination device, the certificate verification unit deletes the authentication information that has been recorded.
(10)
An information processing method causing an information processing device to execute processing, the processing including:

generating, for a transmission source device of an invitation code request for a DIDcomm connection, an invitation code including a session ID that identifies the DIDcomm connection;
performing control to record the session ID received over the DIDcomm connection from a connection destination device that has read the invitation code and a client ID that identifies the transmission source device included in the invitation code request with the session ID and the client ID associated with each other; and
communicating with the connection destination device over the DIDcomm connection, in which
in a case where the DIDcomm connection with the connection destination device has already been established, the DIDcomm connection with the connection destination device is reused.
(11)
A program causing a computer to execute processing, the processing including:
generating, for a transmission source device of an invitation code request for a DIDcomm connection, an invitation code including a session ID that identifies the DIDcomm connection;
performing control to record the session ID received over the DIDcomm connection from a connection destination device that has read the invitation code and a client ID that identifies the transmission source device included in the invitation code request with the session ID and the client ID associated with each other; and
communicating with the connection destination device over the DIDcomm connection, in which
in a case where the DIDcomm connection with the connection destination device has already been established, the DIDcomm connection with the connection destination device is reused.
(12)
An information processing device including:
a readout unit that reads an invitation code for a DIDcomm connection that has been presented;
a control unit that identifies, on the basis of the invitation code, whether or not the DIDcomm connection has already been established with a connection destination device indicated by the invitation code, and reuses the DIDcomm connection with the connection destination device in a case where the DIDcomm connection with the connection destination device has already been established; and
a communication unit that transmits, to the connection destination device over the DIDcomm connection, a session ID that is included in the invitation code and identifies the DIDcomm connection with the connection destination device.
(13)
The information processing device according (12), in which
the control unit generates a certificate in accordance with a request from the connection destination device on the basis of a VC recorded in a wallet, and
the communication unit transmits the certificate to the connection destination device over the DIDcomm connection.
(14)
The information processing device according to (13), in which
the communication unit transmits, to the connection destination device over the DIDcomm connection, flag information indicating a request to delete authentication information including a connection ID used for the DIDcomm connection with the connection destination device and the certificate, the authentication information being recorded in the connection destination device.
(15)
An information processing method causing an information processing device to execute processing, the processing including:
reading an invitation code for a DIDcomm connection that has been presented;
identifying, on the basis of the invitation code, whether or not the DIDcomm connection has already been established with a connection destination device indicated by the invitation code and reusing the DIDcomm connection with the connection destination device in a case where the DIDcomm connection with the connection destination device has already been established; and
transmitting, to the connection destination device over the DIDcomm connection, a session ID that is included in the invitation code and identifies the DIDcomm connection with the connection destination device.
(16)
A program causing a computer to execute processing, the processing including:
reading an invitation code for a DIDcomm connection that has been presented;
identifying, on the basis of the invitation code, whether or not the DIDcomm connection has already been established with a connection destination device indicated by the invitation code and reusing the DIDcomm connection with the connection destination device in a case where the DIDcomm connection with the connection destination device has already been established; and
transmitting, to the connection destination device over the DIDcomm connection, a session ID that is included in the invitation code and identifies the DIDcomm connection with the connection destination device.

### REFERENCE SIGNS LIST

11 Mobile terminal
12 User management site application
13 VC issuing server
14 Service site application
15 Verification server
17 SSI network
31 Recording unit
32 Camera
33 SSI mobile agent
34 Communication unit
35 Display unit
51 Communication unit
52 Session management unit
53 SSI cloud agent
54 ID token generation unit
55 Recording unit

1. An information processing device comprising:
a session management unit that generates, for a transmission source device of an invitation code request for a DIDcomm connection, an invitation code including a session ID that identifies the DIDcomm connection, and performs control to record the session ID received over the DIDcomm connection from a connection destination device that has read the invitation code and a client ID that identifies the transmission source device included in the invitation code request with the session ID and the client ID associated with each other; and
a communication unit that communicates with the connection destination device over the DIDcomm connection, wherein
in a case where the DIDcomm connection with the connection destination device has already been established, the session management unit reuses the DIDcomm connection with the connection destination device.

2. The information processing device according to claim 1, wherein
the session management unit performs control to record the session ID, the client ID, and a connection ID used for the DIDcomm connection with the connection destination device with the session ID, the client ID, and the connection ID associated with each other.

3. The information processing device according to claim 1, further comprising:
a certificate verification unit that verifies a certificate generated on a basis of a VC in a case where the certificate is received from the connection destination device over the DIDcomm connection; and
a generation unit that converts the certificate into another certificate different in format from the certificate.

4. The information processing device according to claim 3, wherein
the another certificate includes an ID token.

5. The information processing device according to claim 3, wherein
the generation unit converts the certificate into the another certificate on a basis of a prerecorded conversion table.

6. The information processing device according to claim 3, wherein
the communication unit transmits the another certificate to the transmission source device.

7. The information processing device according to claim 3, wherein
the certificate verification unit generates authentication information including a connection ID used for the DIDcomm connection with the connection destination device and the certificate and performs control to record the authentication information.

8. The information processing device according to claim 7, wherein
in a case where the authentication information has not been recorded, the certificate verification unit requests the connection destination device to present the certificate.

9. The information processing device according to claim 7, wherein
in a case where there is a request to delete the authentication information from the connection destination device, the certificate verification unit deletes the authentication information that has been recorded.

10. An information processing method causing an information processing device to execute processing, the processing comprising:
generating, for a transmission source device of an invitation code request for a DIDcomm connection, an invitation code including a session ID that identifies the DIDcomm connection;
performing control to record the session ID received over the DIDcomm connection from a connection destination device that has read the invitation code and a client ID that identifies the transmission source device included in the invitation code request with the session ID and the client ID associated with each other; and
communicating with the connection destination device over the DIDcomm connection, wherein
in a case where the DIDcomm connection with the connection destination device has already been established, the DIDcomm connection with the connection destination device is reused.

11. A program causing a computer to execute processing, the processing comprising:
generating, for a transmission source device of an invitation code request for a DIDcomm connection, an invitation code including a session ID that identifies the DIDcomm connection;
performing control to record the session ID received over the DIDcomm connection from a connection destination device that has read the invitation code and a client ID that identifies the transmission source device included in the invitation code request with the session ID and the client ID associated with each other; and
communicating with the connection destination device over the DIDcomm connection, wherein
in a case where the DIDcomm connection with the connection destination device has already been established, the DIDcomm connection with the connection destination device is reused.

12. An information processing device comprising:
a readout unit that reads an invitation code for a DIDcomm connection that has been presented;
a control unit that identifies, on a basis of the invitation code, whether or not the DIDcomm connection has already been established with a connection destination device indicated by the invitation code, and reuses the DIDcomm connection with the connection destination device in a case where the DIDcomm connection with the connection destination device has already been established; and
a communication unit that transmits, to the connection destination device over the DIDcomm connection, a session ID that is included in the invitation code and identifies the DIDcomm connection with the connection destination device.

13. The information processing device according to claim 12, wherein
the control unit generates a certificate in accordance with a request from the connection destination device on a basis of a VC recorded in a wallet, and
the communication unit transmits the certificate to the connection destination device over the DIDcomm connection.

14. The information processing device according to claim 13, wherein
the communication unit transmits, to the connection destination device over the DIDcomm connection, flag information indicating a request to delete authentication information including a connection ID used for the DIDcomm connection with the connection destination device and the certificate, the authentication information being recorded in the connection destination device.

15. An information processing method causing an information processing device to execute processing, the processing comprising:
reading an invitation code for a DIDcomm connection that has been presented;
identifying, on a basis of the invitation code, whether or not the DIDcomm connection has already been established with a connection destination device indicated by the invitation code and reusing the DIDcomm connection with the connection destination device in a case where the DIDcomm connection with the connection destination device has already been established; and
transmitting, to the connection destination device over the DIDcomm connection, a session ID that is included in the invitation code and identifies the DIDcomm connection with the connection destination device.

16. A program causing a computer to execute processing, the processing comprising:
reading an invitation code for a DIDcomm connection that has been presented;
identifying, on a basis of the invitation code, whether or not the DIDcomm connection has already been established with a connection destination device indicated by the invitation code and reusing the DIDcomm connection with the connection destination device in a case where the DIDcomm connection with the connection destination device has already been established; and
transmitting, to the connection destination device over the DIDcomm connection, a session ID that is included in the invitation code and identifies the DIDcomm connection with the connection destination device.
